(19) United States
(12) Patent Application Publication
(10) Pub. No.: US 2005/0125121 A1
(43) Pub. Date: Jun. 9, 2005

(54) Vehicle driving assisting apparatus

(75) Inventors: Kazuyoshi Isaji, Kariya-city (JP); Naohiko Tsuru, Handa-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 10/983,688

(22) Filed: Nov. 9, 2004

(30) Foreign Application Priority Data
Nov. 28, 2003 (JP) 2003-400188
Jan. 9, 2004 (JP) 2004-4471
Jan. 16, 2004 (JP) 2004-9666
Aug. 24, 2004 (JP) 2004-244248

(51) Int. Cl. G06F 17/00

(52) U.S. Cl. 701/36

(57) ABSTRACT

The front scenery of a vehicle is imaged as a picture by a CCD camera. The number of pixels in each horizontal line necessary for traveling of the vehicle is stored, and it is determined whether the vehicle can pass through by a parking vehicle based on a ratio of the number of pixels of the road where no vehicle is parking in the image to the number of pixels of each horizontal line based on the width of the vehicle.

### CROSS REFERENCE TO RELATED APPLICATION

This application is based on and incorporates herein by reference Japanese Patent Applications No. 2003-400188 filed Nov. 28, 2003, No. 2004-4471 filed Jan. 9, 2004, No. 2004-9666 filed Jan. 16, 2004 and No. 2004-244248 filed Aug. 24, 2004.

### FIELD OF THE INVENTION

The present invention relates to an apparatus for assisting driving of a vehicle.

### BACKGROUND OF THE INVENTION

JP-A-9-106500 proposes a vehicle driving assisting apparatus, which provides to a driver the probability of contact or hitting of the vehicle an obstacle bodies such as a vehicle parking ahead while driving the vehicle on a narrow road. According to this apparatus, positional data of the body existing in front of the vehicle are detected, the probability of contact between the vehicle and the detected body is determined based on the positional data of the detected body, and a display or alarm is output based on the determined result.

In this apparatus, a path of future traveling of the vehicle is estimated from the speed of the vehicle and the steering angle thereof in determining the probability of contact to the detected body, and a line for determining the probability of contact is set based on the estimated path of traveling. Then, the probability of contact is determined from a positional relationship between the set line for determining the probability of contact and the edge of the body.

In determining the probability of contact, therefore, it is necessary to detect the speed of the vehicle and the steering angle thereof to set the line for determining the probability of contact based thereupon. It is difficult to quickly determine the probability of contact.

### SUMMARY OF THE INVENTION

In view of the above problem, it is an object of the present invention to provide a vehicle driving assisting apparatus, which is capable of quickly determining whether the vehicle can pass through without contacting or hitting an obstacle body while traveling on a narrow road.

According to one aspect of the present invention, front scenery of a vehicle is imaged as a picture by a camera. From the imaged picture, an available width for a vehicle passing is calculated. A necessary width for passing of a subject vehicle by a front obstacle body is stored. Whether the vehicle can pass by the obstacle body is determined depending upon the relation of the available width and the necessary width.

Preferably, the number of pixels in the horizontal direction of the image necessary for driving the vehicle is stored depending upon the pixel positions in the vertical direction of the image that is imaged. The available width is calculated as the number of pixels of the road where the object is not existing in the image. The determination is made based on the ratio of the number of pixels corresponding to the available width to the stored number of pixels necessary for the traveling.

Unlike the prior art, it is thus possible to quickly determine whether the vehicle can pass through in traveling on a narrow road without the need of detecting the speed of the vehicle and the steering angle thereof or without the need of setting a line for determining the probability of contact based thereupon.

As an alternative, the possibility of passing of the subject vehicle by a front obstacle body is determined by comparing the widths of the preceding vehicle and the subject vehicle, if the preceding vehicle has successfully passed through by the front obstacle body. Specifically, it is so determined that the subject vehicle will not be able to pass by the obstacle body if the width of the subject vehicle is larger than that of the preceding vehicle.

According to another aspect of the present invention, a vehicle front road is imaged by a camera, and data related to traffic regulations and instructions corresponding to the road. A degree of caution is determined based on the data related to traffic regulations and instructions. A display image is formed in a mode of display that differs depending upon the degree of caution.

### BRIEF DESCRIPTION OF THE DRAWINGS

The above and other objects, features and advantages of the present invention will become more apparent from the following detailed description made with reference to the accompanying drawings. In the drawings:

FIG. 1 is a functional block diagram illustrating a vehicle driving assisting apparatus according to a first embodiment of the present invention;

FIG. 2 is a functional block diagram of a computer used in the first embodiment;

FIG. 3 is a view of an image depicting the lane on a road and a parking vehicle ahead of the vehicle that is traveling as imaged by using a CCD camera;

FIG. 4 is a view of an angle of field set on the image that is imaged by the CCD camera;

FIG. 5 is a view illustrating a region comprising pixel positions in the vehicle lane, excluding a parking vehicle which is a body existing in the vehicle lane between the left edge of the vehicle lane and the right edge of the vehicle lane;

FIG. 6 is a view illustrating a width acquired by adding predetermined margins to the width of the vehicle;

FIG. 7 is a view of an image showing the number of pixels of the vertical lines for each horizontal line necessary for the vehicle to travel;

FIG. 8 is a view explaining a case of calculating the ratio of the number of pixels of the vertical lines in the region to the number of pixels of the vertical lines necessary for the vehicle to travel for each horizontal line corresponding to the height of the parking vehicle;

FIG. 9 is a flowchart illustrating computer processing for assisting the driving according to the first embodiment;

FIG. 10 is a functional block diagram of the computer according to a first modification of the first embodiment;

FIG. 11 is a view of an image illustrating a case where a vehicle is going to pass through between the parking vehicle and a vehicle coming on in a single lane according to a third modification of the first embodiment;

FIG. 12 is a view of an image illustrating a case where a vehicle parking along the left edge of the vehicle lane, a vehicle is coming on in the opposite lane, and the vehicle which is traveling is going to pass through between the parking vehicle and the on-coming vehicle;

FIG. 13 is a functional block diagram of the computer according to a second embodiment;

FIG. 14A is a view illustrating a case where the extreme left end position of the parking vehicle is located on the left side of the left edge of the vehicle lane, and FIG. 14B is a view illustrating a case where the extreme left end position VL of the parking vehicle is located on the right side of the left edge of the vehicle lane;

FIG. 15 is a flowchart illustrating computer processing for assisting the driving according to the second embodiment;

FIG. 16 is a functional block diagram of the computer according to a first modification of the second embodiment;

FIG. 17 is a view illustrating the position of the right edge position of the vehicle lane which is used as a reference for calculating a right-side available width when the vehicle travels on a single lane according to a second modification of the second embodiment;

FIG. 18 is a view of an image illustrating a case where a vehicle is going to pass through between the parking vehicle and a vehicle coming on in a single lane according to a third modification of the second embodiment; and

FIG. 19 is a view of an image illustrating a case where a vehicle is parking along the left edge of the vehicle lane, and the vehicle is going to pass through on the right side of the parking vehicle according to a fifth modification of the second embodiment.

FIG. 20 is a functional block diagram of a computer according to a third embodiment;

FIG. 21 is a view of an image depicting a preceding vehicle in front of the vehicle that is traveling, a parking vehicle and an on-coming vehicle as imaged by using a CCD camera;

FIG. 22 is a view of an angle of field set on the image that is imaged by the CCD camera;

FIG. 23 is a view of extracting the number of pixels between the pixel positions at the extreme ends for each horizontal line that indicates the contour of a preceding vehicle;

FIG. 24 is a view of an image showing the number of pixels of the vertical lines for each horizontal line necessary for the vehicle to travel;

FIG. 25 is a flowchart illustrating computer processing for assisting the driving according to the third embodiment;

FIG. 26 is a functional block diagram of the computer according to a modification of the third embodiment;

FIG. 27 is a functional block diagram of the computer according to a fourth embodiment;

FIG. 28 is a flowchart illustrating computer processing for assisting the driving according to the fourth embodiment;

FIG. 29 is a functional block diagram of the computer according to a modification of the fourth embodiment;

FIG. 30 is a schematic view illustrating a display device for vehicles according to a fifth embodiment of the invention;

FIG. 31 is a block diagram illustrating a control unit according to the fifth embodiment;

FIG. 32 is a view of an image including a road in front of the vehicle;

FIG. 33 is a flowchart illustrating processing by the display device for vehicles according to the fifth embodiment;

FIG. 34 is a view of an image displayed on a display region of a windshield according to a first modification of the fifth embodiment;

FIG. 35 is a view of an image displayed in colors that differ depending upon the distance according to a second modification of the fifth embodiment;

FIG. 36 is a view of an image displaying traveling loci according to a third modification of the fifth embodiment;

FIG. 37 is a view of when an on-coming vehicle located in the opposite lane is overlapping the image displaying the traveling loci according to a fourth modification of the fifth embodiment;

FIG. 38 is a view of when the on-coming vehicle located in the opposite lane is not overlapping the image displaying the traveling loci according to the fourth modification of the fifth embodiment; and

FIG. 39 is a view of when a preceding vehicle in the traveling lane of the vehicle is positioned on the traveling loci according to the fourth modification of the fifth embodiment.

### DETAILED DESCRIPTION OF THE PREFERRED EMBODIMENT

A vehicle driving assisting apparatus of the present invention will now be described with reference various embodiments and modifications.

### First Embodiment

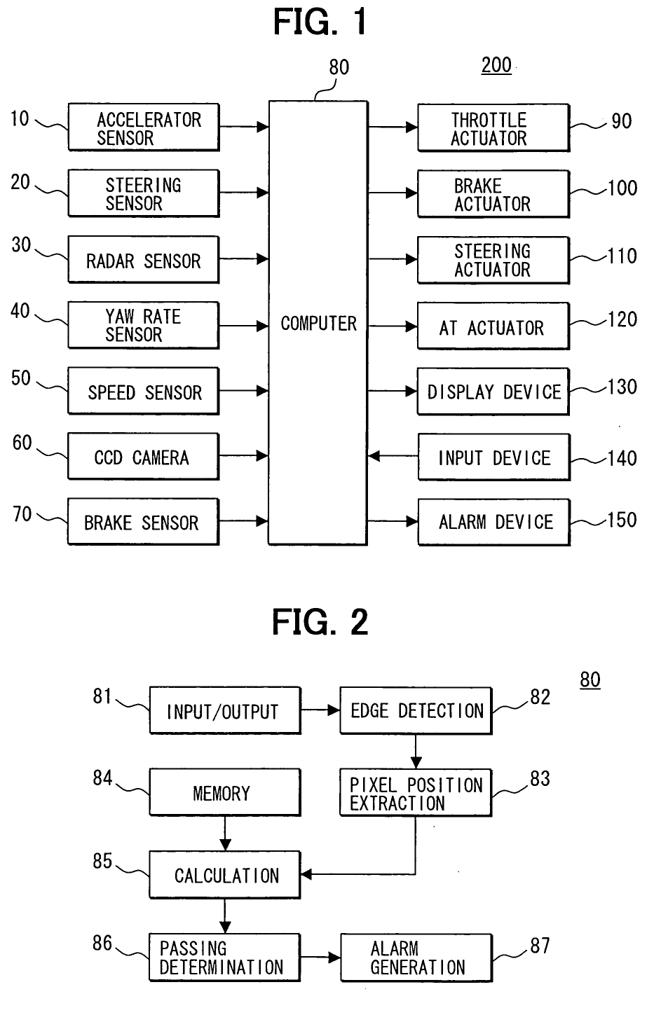

Referring to FIG. 1, a vehicle driving assisting apparatus 200 includes an accelerator sensor 10, a steering sensor 20, a laser radar sensor 30, a yaw rate sensor 40, a vehicle speed sensor 50, a CCD camera 60 and a brake sensor 70, which are connected to a computer 80.

The apparatus 200 further includes a throttle actuator 90, a brake actuator 100, a steering actuator 110, an automatic transmission (A/T) actuator 120, a display device 130, an input device 140 and an alarm device 150, which are also connected to the computer 80.

The computer 80 includes an input/output interface (I/O) and various drive circuits that are not shown. The above hardware constructions are those that are generally known and employed in this kind of apparatus. When the vehicle travels on a narrow road, the computer 80 determines whether the vehicle can pass through, and executes the processing for assisting the driving on a narrow road based on the determined result.

Based on the data from the sensors, further, the computer 80 operates to drive the throttle actuator 90, brake actuator 100, steering actuator 110, and automatic transmission actuator 120 thereby to execute the traveling control processing such as a lane-maintaining travel control for traveling of the vehicle maintaining the traveling lane and a inter-vehicle distance control for traveling of the vehicle maintaining a proper time relative to the vehicle in front.

The accelerator sensor 10 detects the on/off of the accelerator pedal operation by a driver. The detected operation signal of the accelerator pedal is sent to the computer 80. The steering sensor 20 detects the amount of change in the steering angle of the steering wheel, and a relative steering angle is detected from a value thereof.

The laser radar sensor 30 projects a laser beam over a predetermined range in front of the vehicle, and detects the distance to the reflecting bodies such as a body in front that is reflecting the laser beam, speed relative thereto, and azimuth of the reflecting body to the vehicle. The body data comprised of the detected results are converted into electric signals and are output to the computer 80. The laser radar sensor 30 detects the body by using the laser beam. However, the bodies surrounding the vehicle may be detected by using electromagnetic waves or ultrasonic waves such as millimeter waves or micro waves.

The yaw rate sensor 40 detects the angular velocity about the vertical axis of the vehicle. The vehicle speed sensor 50 detects the rotational speed of a wheel. The braking sensor 70 detects on/off of the brake pedal operation by the driver.

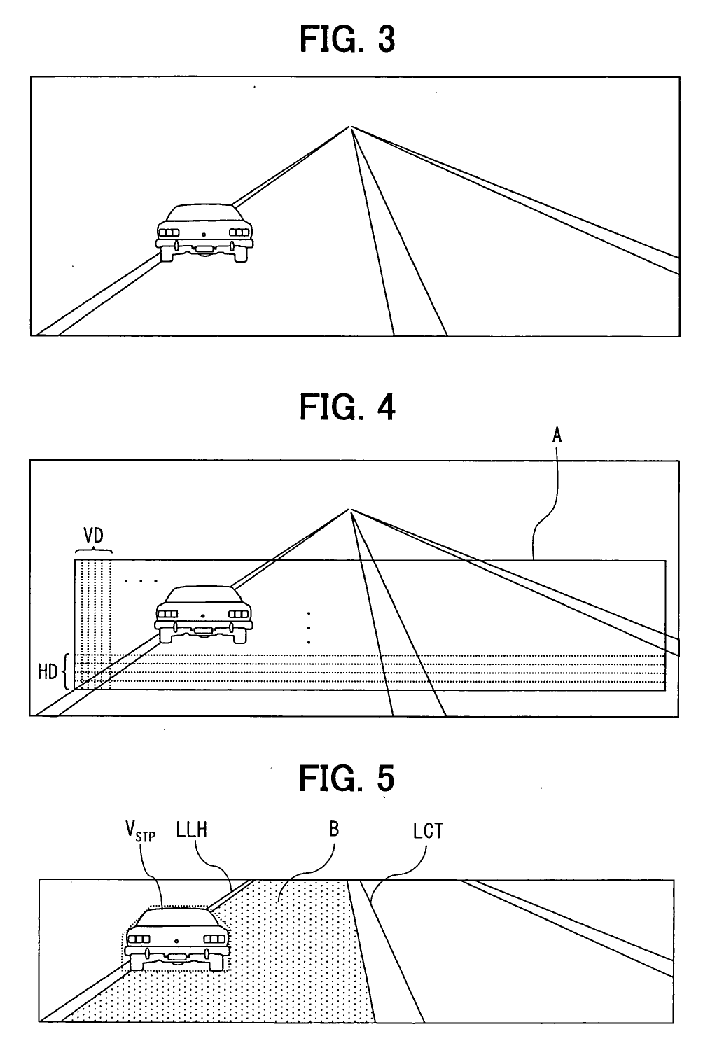

The CCD camera 60 is an opto-electric camera provided at a position where it images the front of the vehicle. The CCD camera 60 images the vehicle lanes indicating the traveling sections of the vehicle on the road in front and the parking vehicles as shown in, for example, FIG. 3. The CCD camera 60 is so constructed as to adjust the shutter speed, frame rate and gain of the digital signals output to the computer 80 depending upon the instructions from the computer 80. The CCD camera 60 further outputs, to the computer 80, digital signals of pixel values representing the degrees of brightness of pixels of the image that is imaged together with the horizontal and vertical synchronizing signals of the image that is imaged.

The throttle actuator 90, brake actuator 100, steering actuator 110 and automatic transmission actuator 120 all operate in response to the instructions from the computer 80. The throttle actuator 90 adjusts the opening degree of the throttle valve to control the output of the internal combustion engine. The brake actuator 100 adjusts the braking pressure, and the steering actuator 110 enables the steering to generate a rotational torque thereby to drive the steering. The automatic transmission actuator 120 selects the gear position of the automatic transmission which is necessary for controlling the speed of the vehicle.

The display device 130 is constructed with, for example, a liquid crystal display, and is installed near the center console in the vehicle compartment. The display device 130 receives image data of alarm display output from the computer 80, and displays images corresponding to the image data to evoke the driver's caution.

The input device 140 is, for example, a touch switch or a mechanical switch integral with the display device 130, and is used for inputting a variety of inputs such as characters. The alarm device 150 is for producing an alarm sound for evoking the driver's caution, and produces an alarm in response to an instruction from the computer 80.

In the lane-maintaining travel control, for example, the alarm is produced in case the vehicle goes off the traveling lane. In the inter-vehicle distance control, the alarm is produced when the vehicle quickly approaches the vehicle in front in excess of the control limit (minimum distance to the preceding vehicle) in the inter-vehicle distance control.

Next, FIG. 2 is a functional block diagram of the computer 80. As shown in FIG. 2, the control processing of the computer 80 is divided into blocks of an input/output unit 81, an edge detection unit 82, a pixel position extraction unit 83, a memory 84, a calculation unit 85, a subject vehicle passing determination unit 86 and an alarm generation unit 87.

The input/output unit 81 receives signals output from the sensors, and produces signals that are processed by the computer 80 and that are to be output.

First, the edge detection unit 82 acquires pixel values only for the pixels in the angle of field in an image that has been preset out of the pixel values for the pixels of the whole image imaged by the CCD camera 60. As an angle of field for acquiring the pixel values, for example, an angle or area of field A is set as shown in FIG. 4 to include a vehicle lane from several meters up to several tens of meters in front of the vehicle. This is for acquiring pixel values of only the pixels on the horizontal lines (HD) and on the vertical lines (VD) in the angle of field A. The pixel values that can be assumed in this embodiment are in a range of, for example, from 0 to 255 (256 gradations). It is noted that the horizontal line HD is positioned higher from the lower side to the upper side as the distance from the vehicle becomes longer.

Next, the edge detection unit 82 detects the edge to extract the pixel positions that indicate pixel values greater than the threshold edge value by comparing the acquired values of pixels in the angle of field with a preset threshold edge value. The threshold edge value is set based on the pixel values corresponding to the bodies such as the road, vehicle lane on the road, parking vehicles and on-coming vehicles that are usually imaged by the CCD camera 60. By using the threshold edge value that is set, the pixel positions corresponding to the road, vehicle lane on the road and bodies are extracted. The edge detection is repetitively effected from, for example, the uppermost portion of the horizontal lines (HD) to the lowermost portion thereof in the angle of field A, from the pixel at the extreme left end to the pixel at the extreme right end of the vertical lines (VD).

In this embodiment, obstacle bodies such as vehicles existing but moving in front of the vehicle that is traveling are excluded from the objects to be detected. For this purpose, for example, the pixel positions of the body detected by the edge detection unit 82 are stored, the vehicle traveling in the same direction as the vehicle that is now traveling is specified as a preceding vehicle from the stored history. The thus specified preceding vehicle that is moving is excluded from the object that is to be detected. Therefore, the preceding moving vehicle is not erroneously detected as the obstacle body (parking vehicle).

The pixel position extraction unit 83 extracts the pixel positions in the vehicle lane except the pixels corresponding to the bodies between the pixel positions corresponding to the right edge and the left edge of the vehicle lane extracted by the edge detection unit 82. As shown in, for example, FIG. 5, therefore, there is extracted a region B comprising pixel positions in the vehicle lane except the parking vehicle V_{STP} which is a stopping body existing in the vehicle lane between the left edge LLH of the vehicle lane and the right edge LCT of the vehicle lane.

Here, there is no need of extracting all pixel positions of the region B. Namely, there may be extracted only pixel positions of the vertical line (VD), which becomes a boundary in the transverse direction of the region B for each horizontal line (HD). Further, there may be extracted only those pixel positions of the vertical line (VD) that becomes a boundary in the transverse direction of the region B for each horizontal line (HD) corresponding to the height of the parking vehicle V_{STP}.

Namely, the apparatus 200 determines whether the vehicle can pass through as it travels by the body existing in front. By extracting the pixel positions only of the vertical line (VD) that becomes the boundary in the transverse direction of the region B for each horizontal line (HD) corresponding to the height of the vehicle V_{STP} at rest, the processing time can be shortened for determining the passage.

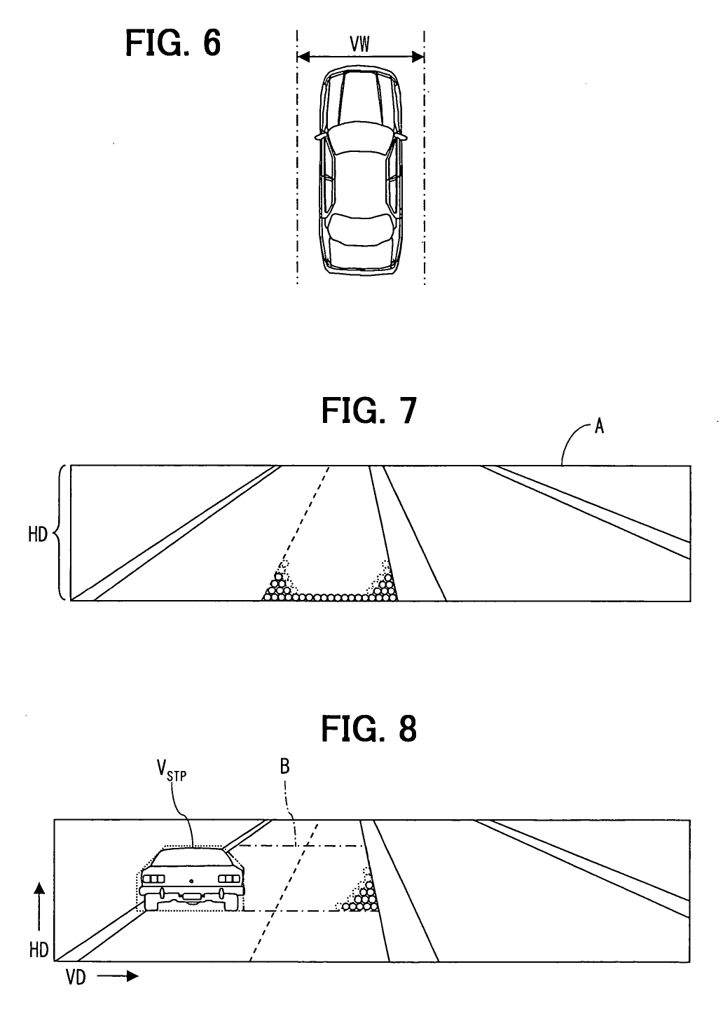

The memory 84 stores the number of pixels in the horizontal (left and right) direction for each horizontal line (HD) as a width necessary for traveling of the vehicle at the angle of field A with respect to different forward distances from the vehicle. Referring to FIG. 6, the number of pixels is set by converting the width (VW) acquired by adding predetermined margins to the actual width of a vehicle into the angle of field A. Referring, for example, to FIG. 7, the number of pixels converted into the angle of field A decreases toward the upper portion of the horizontal lines (HD), that is, as the forward distance from the vehicle increases.

The calculation unit 85 calculates the ratio (Rhd) of the number of pixels in the horizontal direction in the region B to the number of pixels in the same horizontal direction necessary for traveling of the vehicle stored in the memory 84 for each horizontal line (HD) corresponding to the height of the parking vehicle V_{STP}, that is, corresponding to the forward distance from the vehicle, as shown in, for example, FIG. 8.

The subject vehicle passing determination unit 86 determines whether the ratio (Rhd) for each horizontal line (HD) calculated by the calculation unit 85 is smaller than a predetermined ratio (Rr) of the number of pixels in the horizontal direction for each horizontal lines (HD) corresponding to the width of the subject vehicle. The determined result is sent to the alarm generation unit 87.

When the passing determination unit 86 determines that the ratio (Rhd) for each horizontal line (HD) is smaller than the ratio (Rr) of the number of pixels of the vertical line (VD) for each horizontal line (HD) corresponding to the width of the vehicle, the alarm generation unit 87 generates alarm for evoking the caution of the vehicle driver. For example, an alarm is generated to notify that the vehicle cannot pass by the vehicle parking ahead. Therefore, the driver of the vehicle learns that he cannot pass by the vehicle that is parking.

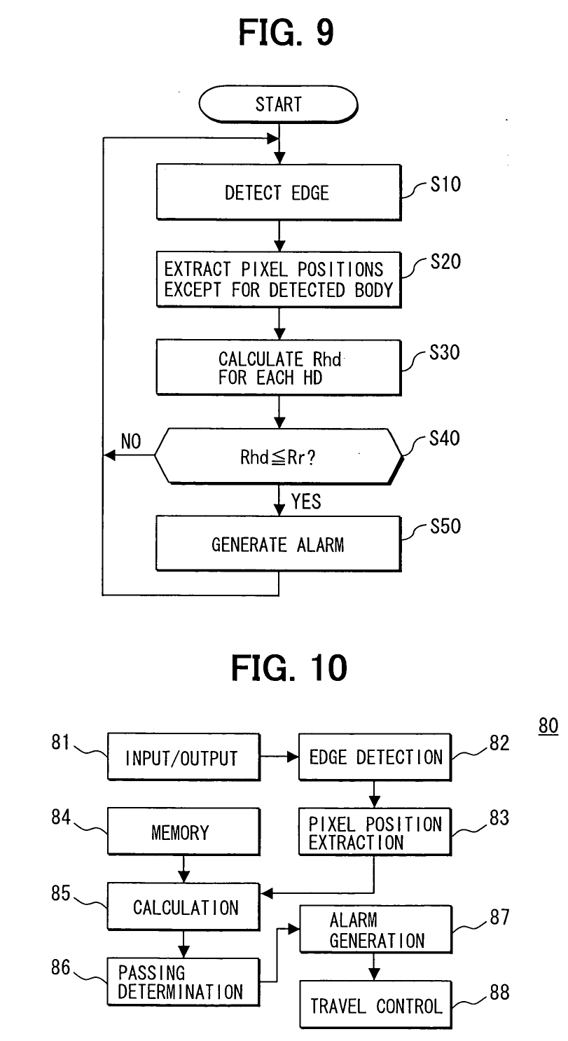

The computer processing for assisting the driving on a narrow road is shown in FIG. 9. First, at step (S)10, the pixel positions corresponding to the vehicle lane and the body are extracted based on the edge detection. At S20, the pixel positions are extracted in the vehicle lane except the body in the vehicle lane detected at S10.

At S30, the ratio (Rhd) of the number of pixels of the horizontal lines (HD) in the vehicle lane excluding the body in the vehicle lane, is calculated relative to the number of pixels for each horizontal line (HD) necessary for traveling of the vehicle.

At S40, it is determined whether the ratio (Rhd) calculated at S30 is smaller than the ratio (Rr) of the number of pixels for each horizontal line (HD) stored based on the width of the vehicle. When the result is affirmative, the routine proceeds to S50. When the result is negative, the routine returns to S10 to repeat the above processing. At S250n alarm is generated to evoke the driver's caution.

In this embodiment, the apparatus 200 stores the number of pixels in the horizontal direction for each horizontal line (HD) necessary for traveling of the vehicle, and determines whether the vehicle can pass through by the body based on the ratio (Rhd) of the number of pixels of the road where no body is present in the image that is imaged to the number of pixels necessary for the traveling and upon the ratio (Rr) of the number of pixels in the horizontal direction for each horizontal line (HD) based on the width of the vehicle.

Unlike the prior art, therefore, there is no need of detecting the speed of the vehicle or the steering angle thereof, or of setting a line for determining the probability of contact based thereon, making it possible to quickly determine whether the vehicle can pass through while traveling on a narrow road.

As a first modification of the first embodiment, it is possible, for example, to impose limitation on the traveling of the vehicle simultaneously with the generation of alarm. As shown in, for example, FIG. 10, a vehicle travel control unit 88 is added as a function of the computer 80. The vehicle travel control unit 88 controls the throttle actuator 90 so that the driver's accelerator operation for vehicle acceleration is invalidated to limit the accelerator operation for the vehicle acceleration or to drive the brake actuator 100 to automatically apply the brake of the vehicle. This makes it possible to prevent in advance the contact of the vehicle with the body present in the vehicle lane or to reduce the shock should the contact occurs.

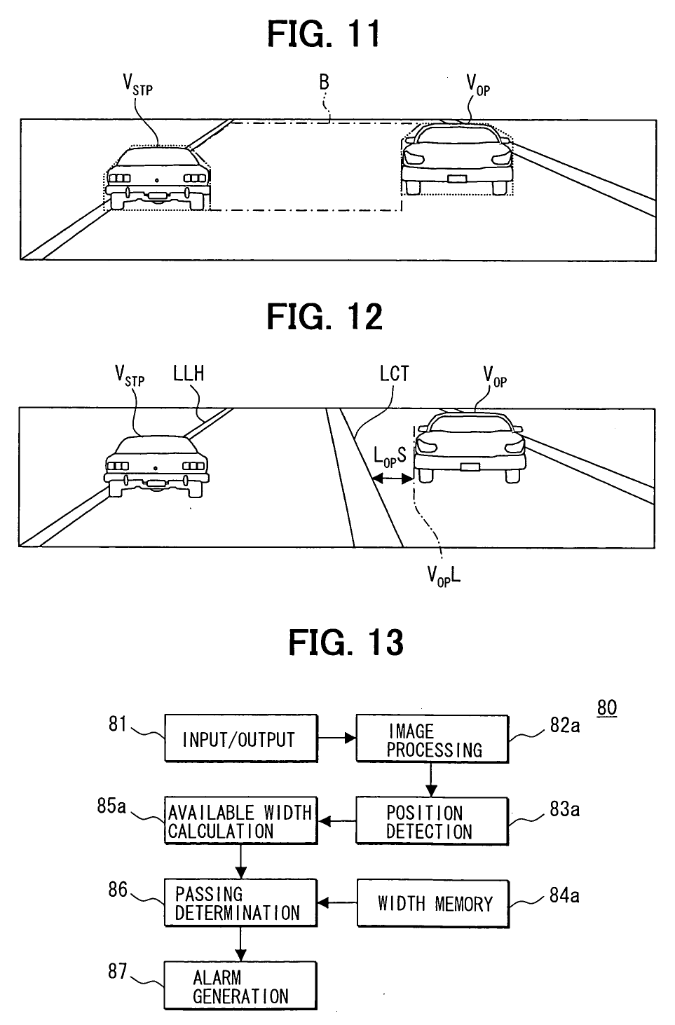

As a second modification, the first embodiment can be applied even when a plurality of bodies are detected as bodies. When two vehicles V_{STP} and V_{OP} (shown as facing in the opposite direction to the vehicle V_{STP}) in a single lane as shown in, for example, FIG. 11, a region B comprising the pixel positions in the vehicle lane between the parking vehicles V_{STP} and V_{OP} is extracted.

Then, the ratio (Rhd) of the number of pixels in the horizontal direction of the region B that is extracted is calculated relative to the number of pixels in the horizontal direction necessary for traveling of the vehicle stored in the memory 84 to finally determine whether the vehicle can pass through. This makes it possible to properly determine whether the vehicle can pass through in circumstances where, for example, two vehicles are parking on the horizontal sides of the road.

As a third modification, in case the vehicle Vₒₚ is also traveling, the apparatus 200 detects the extreme left end position of the on-coming vehicle, and determines whether the vehicle can pass through based on a positional relationship between the extreme left end position of the on-coming vehicle that is detected and the right edge of the vehicle lane.

As shown in, for example, FIG. 12, the vehicle V_{STP} is parking along the left ledge LLH of the vehicle lane, and the vehicle that is traveling is going to pass on the right side of the parking vehicle V_{STP}. In this case, the driver of the vehicle determines whether he should pass by the right side of the parking vehicle V_{STP} or should wait behind the parking vehicle V_{STP} until the on-coming vehicle V_{OP} passes by depending upon the right-left position of the on-coming vehicle V_{OP} traveling in the opposite lane.

That is, when the position of the right edge LCT of the vehicle lane which is the center line and the extreme left end position V_{OP}L of the on-coming vehicle V_{OP} is separated away from each other to some extent (the distance L_{OP}S is long to some extent), the driver of the vehicle usually so determines that the on-coming vehicle V_{OP} travels keeping the present right-left position in the opposite lane, or presumes that the on-coming vehicle V_{OP} does not run out of the right edge LCT of the vehicle lane in a short period of time. Namely, the driver determines whether he should pass by the right side of the parking vehicle V_{STP} relying on the distance between the right side position of the parking vehicle V_{STP} and the position of the right edge LCT of the vehicle lane.

When the position of the right edge LCT of the vehicle lane and the extreme left end position V_{OP}L of the on-coming vehicle V_{OP} are close to each other (the distance L_{OP}S is short), on the other hand, the driver of the vehicle usually so determines that the on-coming vehicle V_{OP} may run out of the right edge LCT of the vehicle lane in a short period of time. In this case, the driver of the vehicle determines whether he should pass by the right side of the parking vehicle V_{STP} relying on the distance between the right side position of the parking vehicle V_{STP} and the extreme left end position V_{OP}L of the on-coming vehicle V_{OP} presuming that the on-coming vehicle V_{OP} may run out of the right edge LCT of the vehicle lane.

By determining the passage based on the positional relationship between the extreme left end position V_{OP}L of the on-coming vehicle and the right edge LCT of the vehicle lane which is the center line, therefore, the driver of the vehicle is possible to determine the passage that matches with his sense of vehicle width.

To realize this third modification, step S20 of FIG. 9 may extract the pixel positions where there is no body in the vehicle lane or may extraction the pixel positions where there is no body between the left edge of the vehicle lane and the extreme left end position of the body in the opposite lane when the pixel position at the extreme left end of the body in the opposite lane is positioned on the left of the pixel position of the right edge of the vehicle lane, or when the number of pixels in the horizontal direction of the image between the pixel position of the extreme left end of the body in the opposite lane and the pixel position of the right edge of the vehicle lane, is smaller than the number of pixels corresponding to the pixel positions in the vertical direction of the image that has been set in advance.

As a fourth modification, it is also possible to compare the calculated number of pixels in the horizontal direction (available width) for each horizontal line (each forward distance from the vehicle) without calculating the ratio to determine whether the vehicle can pass by the body.

### Second Embodiment

The second embodiment of the apparatus 200 is shown in FIG. 13. In this embodiment, the control processing of the computer 80 is divided into the blocks of an input/output unit 81, an image processing unit 82a, a position detection unit 83a, an available width calculation unit 85a, a necessary traveling width memory 84a, a passing determination unit 86 and an alarm generation unit 87.

The image processing unit 82a acquires pixel values only of the pixels in the angle of field in the image that has been preset out of the pixel values of the pixels of the whole image imaged by the CCD camera 60. As the angle of field for acquiring the pixel values, for example, there is set an angle of field A including a vehicle lane from several meters up to several tens of meters in front of the vehicle as shown in FIG. 4, to acquire pixel values only of the pixels on the horizontal lines (HD) and on the vertical lines (VD) in the angle of field A.

Next, the image processing unit 82a detects the edge to extract the pixel positions that indicates pixel values greater than the threshold edge value by comparing the acquired values of pixels in the angle of field with a preset threshold edge value. Thus, there are extracted the pixel positions corresponding to the lane and the body in the angle of field.

The edge detection is repetitively effected from, for example, the uppermost horizontal line to the lowermost horizontal line in the angle of field A, and from the pixels at the left ends to the pixels at the right ends of the horizontal lines. The image processing unit 82a effects the processing such as linear interpolation for the pixel positions that are extracted to form contour images of the lanes and bodies. The lanes and bodies are detected based on the thus formed contour images.

In this embodiment, vehicles existing in front of the vehicle that is traveling are excluded from the objects to be detected. For example, the position of the body detected by the image processing unit 82a is stored, the vehicle traveling in the same direction as the vehicle that is now traveling is specified as a preceding vehicle from the stored history, and the specified preceding vehicle is excluded from the object that is to be detected as an obstacle body. Therefore, the preceding moving vehicle is not erroneously detected as the parking vehicle.

The position detection unit 83a detects the position of the lane and the extreme horizontal end positions of the body from the contour images of the lane and the body finally formed by the image processing unit 82a. Here, the center position of the lane is calculated in advance from the right edge position and the left edge position of the lane that have been detected. There are thus detected the positions of the edges of the lane (vehicle lane) on the right side and the left side of the vehicle as well as the horizontal extreme end positions of the body located in the vehicle lane. The following description deals with the center positions of the horizontal edges of the vehicle lane as the positions of the lane.

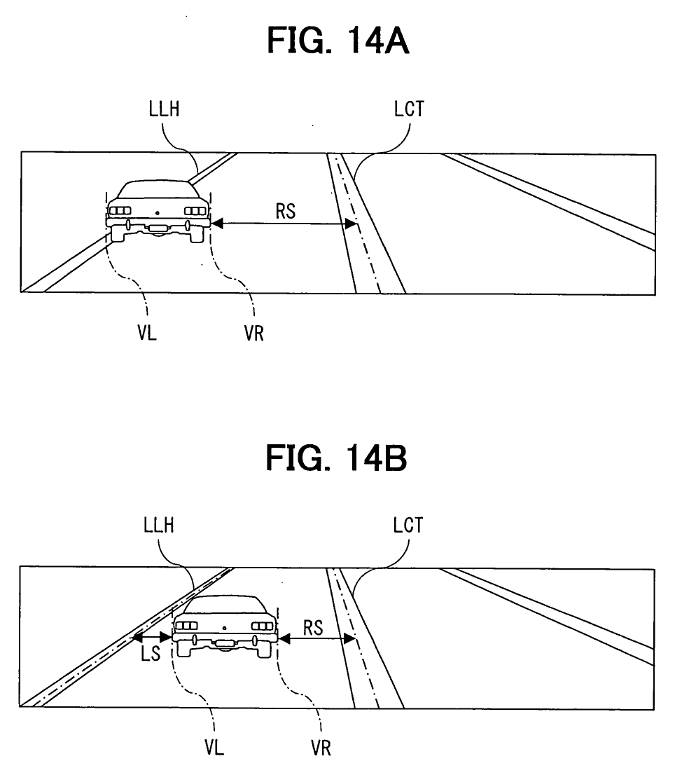

The available width calculation unit 85a calculates the available width in the vehicle lane based on the positions of the horizontal edges of the vehicle lane and extreme horizontal ends of the body detected by the position detection unit 83a. Referring, for example, to FIG. 14A, there are detected the left edge LLH of the vehicle lane, right edge LCT of the vehicle lane, extreme left end VL and the extreme right end VR of the parking vehicle. In this case, there is calculated the right-side available width RS which is a length from the position of the extreme right end VR of the parking vehicle to the position of the right edge LCT of the vehicle lane.

This calculation may be attained based on the number of pixels in the horizontal direction between the right edge position VR of the vehicle and the right edge LCT of the vehicle lane. This calculation need be made in consideration of the forward distance from the vehicle to the parking vehicle, because the number of pixels varies with the forward distance.

Referring to FIG. 14A, the available width RS on the right side only is calculated when the extreme left end position VL of the parking vehicle is nearly equal to the position of the left edge LLH of the vehicle lane or when the extreme left end position VL of the parking vehicle is further on the left side beyond the position of the left edge LLH of the vehicle lane.

When the extreme left end position VL of the parking vehicle is on the right side of the position of the left edge LLH of the vehicle lane as shown in FIG. 14B, it is preferred to also calculate the left-side available width LS which is a length from the extreme left end position VL of the parking vehicle to the position of the left edge LLH of the vehicle lane.

The necessary traveling width memory 84a stores the necessary traveling width VW which is acquired by adding margins to the horizontal extreme ends of the vehicle.

The passing determination unit 86 compares the right-side available width RS or the left-side available width LS calculated by the available width calculation unit 85a with the necessary traveling width VW, and determines whether the right-side available width RS or the left-side available width LS is shorter than the necessary traveling width VW. The determined result is sent to the alarm generation unit 87.

When the determined result indicating that the right-side available width RS and the left-side available width LS are shorter than the necessary traveling width VW is received from the passing determination unit 86, the alarm generation unit 87 generates alarm for evoking the caution of the vehicle driver. For example, an alarm is generated to notify that the vehicle cannot pass by the vehicle parking ahead. The driver of the vehicle is thus notified that he cannot pass by the parking vehicle in front.

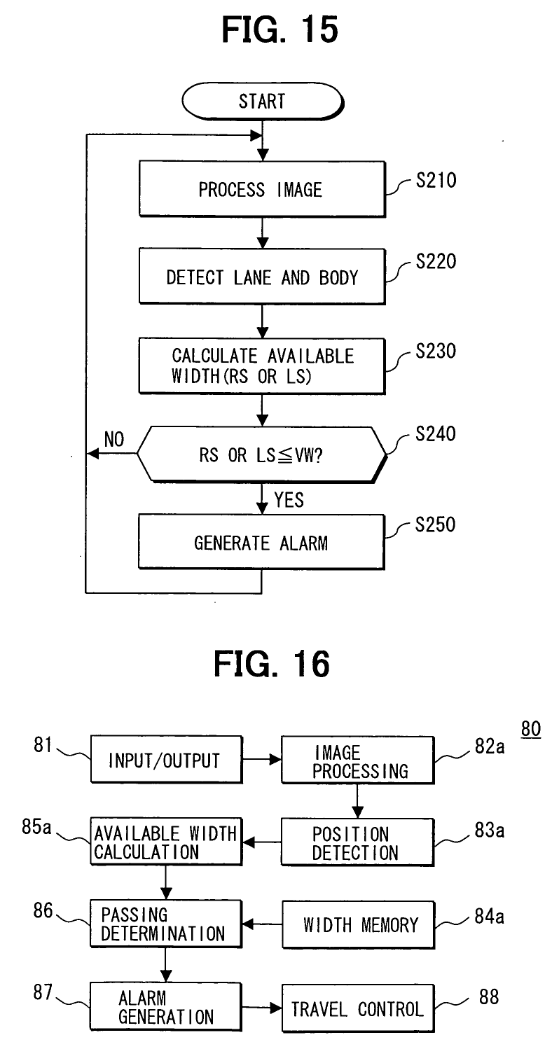

This computer processing is shown in FIG. 15. First, at S210, the image is processed to detect the vehicle lane and the body positioned in the vehicle lane. At S220, there are detected the position of the vehicle lane detected at S210 and the position of the body in the vehicle lane. At S230, an available width is calculated from the position of the vehicle lane and the position of the body detected at S220.

At S240, it is determined whether the available width RS or LS calculated at S230 is smaller than the required traveling width VW (available width is narrower than the necessary traveling width). When the result is affirmative, the routine proceeds to S250. When the result is negative, the routine returns to S210 to repeat the above processing. At S250, the alarm is produced to evoke the driver's caution.

In this embodiment, the apparatus 200 detects the positions of the horizontal edges of the vehicle lane and the positions of the extreme horizontal ends of the body in the vehicle lane, calculates the available widths from the horizontal extreme ends of the body to the edges of the vehicle lane based on the thus detected vehicle lane and the positions of the extreme ends of the body, and generates the alarm to evoke the driver's caution when the available width that is calculated is shorter than the necessary traveling width.

In driving the vehicle on a lane in a direction in which it travels, therefore, it is possible to properly determine the cases where the vehicle is not permitted to pass through on either the right side or the left side of the body existing on the vehicle lane. When the vehicle cannot pass through, an alarm is generated to evoke the driver's caution.

As a first modification of the second embodiment, it is also allowable, for example, to impose limitation on the traveling of the vehicle simultaneously with the generation of alarm.

As shown in, for example, FIG. 16, a vehicle travel control unit 88 is added as a function of the computer 80. The vehicle travel control unit 88 controls the throttle actuator 90 so that the driver's accelerator operation for the vehicle acceleration is invalidated to limit the accelerator operation for acceleration or to drive the brake actuator 100 to automatically apply the brake of the vehicle. This makes it possible to prevent the contact of the vehicle with the body present in the vehicle lane in advance or to reduce the shock should the contact occurs.

In the second embodiment, as shown in FIG. 14A, the right edge LCT of the vehicle lane is used as a reference for calculating the right-side available width RS. When the vehicle travels on a single lane, for example, the right edge LCT of the vehicle lane that corresponds to the center line is not provided in many cases.

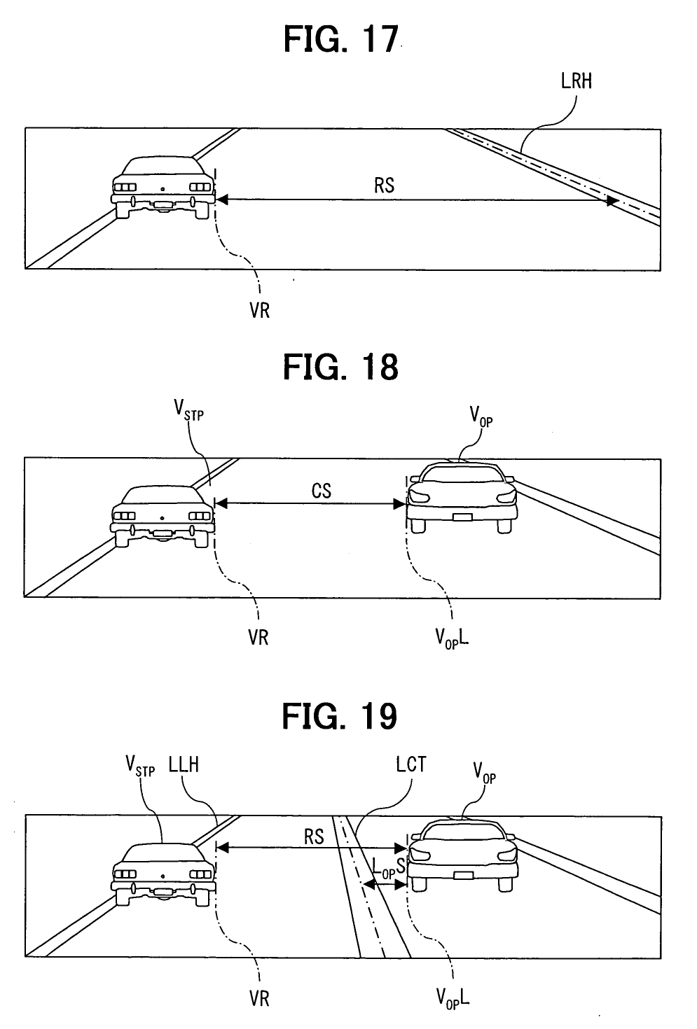

As a second modification of the second embodiment, as shown in, for example, FIG. 17, the right-side available width RS may be calculated from the position of the extreme right end VR of the parking vehicle to the position of the right edge LRH of the single vehicle lane. This makes it possible to properly determine the cases where it is not possible to pass by either the right side or the left side of the body on the single lane on where the vehicle is traveling.

As a third modification, when the vehicle travels on a single lane as shown in, for example, FIG. 18, a parking vehicle V_{STP} and an on-coming vehicle V_{OP} may be detected at nearly the same distances from the vehicle that is traveling. In this case, an available width CS is calculated, which is a length between the position of the extreme right end VR of the parking vehicle V_{STP} and the extreme left end of the on-coming vehicle V_{OP}. The relationship of magnitude is determined between the thus calculated available width CS and the necessary traveling width VW. This makes it possible to properly determine whether the vehicle can pass through between the two parking vehicles in such cases where two vehicles are parking on the horizontal sides of the road.

In relatively narrow roads such as farm roads and roads in the residential areas, however, the lane is not provided in many cases. In such a case, as a fourth modification of the second embodiment, boundary positions at the left and right the road may be detected, and the available width may be calculated from the detected boundary positions at the left and right the road and from the extreme horizontal ends of the body on the road. Then, even on the road where no lane is provided, it is possible to properly determine the cases where the vehicle is possible to pass by either the right side or the left side of the body on the road on where the vehicle is traveling.

As a fifth modification of this embodiment, the apparatus 200 detects the extreme end position of the on-coming vehicle, and changes the position for calculating the right-side available width into the position of the right edge of the vehicle lane or into the extreme left end position of the on-coming vehicle depending on a positional relationship between the extreme left end position of the on-coming vehicle and the right edge of the vehicle lane that are detected.

Referring, for example, to FIG. 19, when the vehicle that is traveling is going to pass by the right side of a vehicle V_{STP} that is parked along the left edge LLH of the vehicle lane, the driver of the vehicle determines whether he should pass the right side of the parking vehicle V_{STP} or should wait behind the parking vehicle V_{STP} until the on-coming vehicle V_{OP} passes away depending upon the position of the on-coming vehicle V_{OP} that is traveling in the opposite lane.

That is, when the position of the right edge LCT of the vehicle lane which is the center line is separated away from the extreme left end position V_{OP}L of the on-coming vehicle V_{OP} to some extent (the distance L_{OP}S is large to some extent), the driver of the vehicle usually so determines that the on-coming vehicle V_{OP} travels keeping the present right-left position in the opposite lane or so presumes that the on-coming vehicle V_{OP} does not run out of the right edge LCT of the vehicle lane in a short period of time.

The driver of the vehicle then determines whether he can pass by the right side of the parking vehicle V_{STP} based on the length from the extreme right end position VR of the parking vehicle V_{STP} to the position of the right edge LCT of the vehicle lane and the necessary traveling width necessary for traveling of the vehicle.

On the other hand, when the position of the right edge LCT of the vehicle lane is close to the extreme left end position V_{OP}L of the on-coming vehicle V_{OP} (when the distance L_{OP}S is short), the driver of the vehicle usually so determines that the on-coming vehicle V_{OP} may run out of the right edge LCT of the vehicle lane in a short period of time.

In such a case, the driver of the vehicle determines whether he can pass through by the right side of the parking vehicle V_{STP} based on the necessary traveling width VW necessary for the vehicle to travel and the right-side available width RS representing the length from the extreme right end position VR of the parking vehicle V_{STP} to the extreme left end position V_{OP}L of the on-coming vehicle V_{OP} taking into consideration the probability of contact with the on-coming vehicle V_{OP} though the extreme left end position V_{OP}L of the on-coming vehicle V_{OP} is not really running out of the right edge LCT of the vehicle lane.

To realize this fifth modification, the position of the on-coming vehicle in the opposite lane should be detected together with the vehicle lane and the position of the body in the vehicle lane at S220 in FIG. 15. Then, at S30, the length from the extreme right end position of the body in the vehicle lane to the extreme left end position of the on-coming vehicle should be calculated as the right-side available width at the time of calculating the right-side available width when the extreme left end position of the on-coming vehicle maintains a shorter distance to the center of the vehicle lane than the distance from the right edge of the vehicle lane, or when the distance between the extreme left end position of the on-coming vehicle and the position of the right edge of the vehicle lane is smaller than a predetermined distance.

By changing the position for calculating the right-side available width into the position of the right edge of the vehicle lane or into the position of the extreme left end of the on-coming vehicle depending upon the position of the extreme left end of the on-coming vehicle, as described above, the driver of the vehicle is possible to set the available width that matches with his sense of vehicle width.

### Third Embodiment

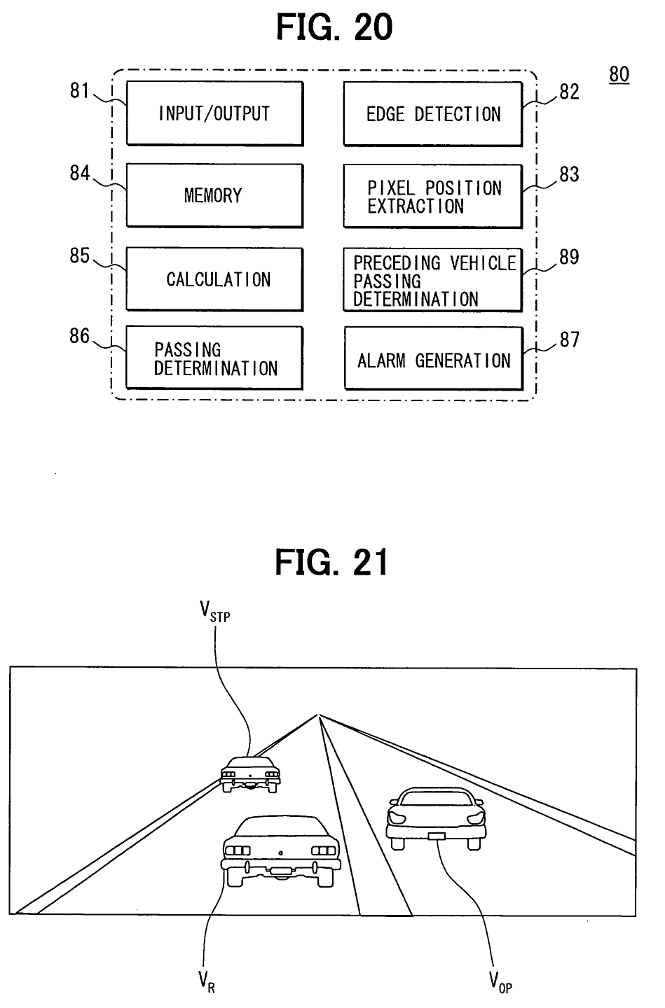

In a third embodiment shown in FIG. 20, the control processing of the computer 80 is divided into the blocks of an input/output unit 81, an edge detection unit 82, a pixel position extraction unit 83, a memory 84, a calculation unit 85, a preceding vehicle passing determination unit 89, a vehicle passing determination unit 86 and an alarm generation unit 87. The input/output unit 81 receives signals output from the sensors, and produces signals that are processed by the computer 80 and that are to be output.

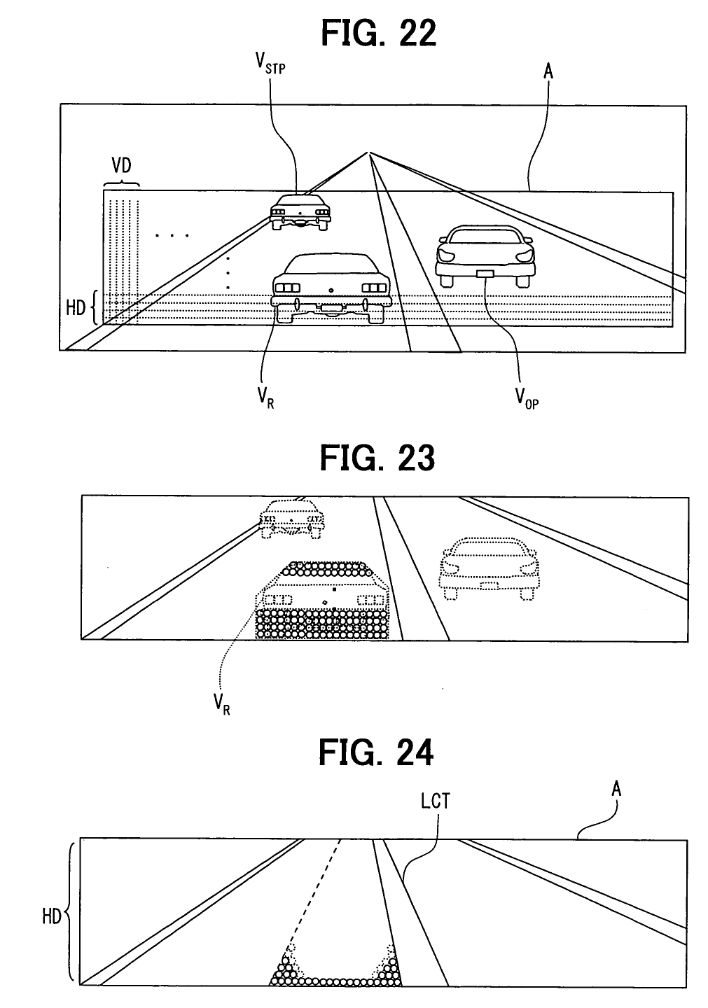

First, the edge detection unit 82 acquires pixel values only of the pixels in the angle of field in an image that has been preset out of the pixel values of the pixels of the whole image imaged by the CCD camera 60. As an angle of field for acquiring the pixel values, for example, an angle of field A is set as shown in FIG. 22 to include a vehicle lane from several meters up to several tens of meters in front of the vehicle. This is for acquiring pixel values of the pixels on the horizontal lines (HD) and on the vertical lines (VD) in the angle of field A. The pixel values that can be assumed in this embodiment are in a range of, for example, from 0 to 255 (256 gradations).

Next, the edge detection unit 82 detects the edge to extract the pixel positions that indicate pixel values greater than the threshold edge value by comparing the acquired values of pixels in the angle of field with a preset threshold edge value. The threshold edge value is set based on the pixel values corresponding to the traveling lane and obstacle bodies such as vehicles that are usually imaged by the CCD camera 60. By using the threshold edge value that is set, the pixel positions corresponding to the traveling lane on the road and vehicles are extracted.

The edge detection is repetitively effected from, for example, the uppermost portion of the horizontal lines (HD) to the lowermost portion thereof in the angle of field A, from the pixel at the extreme left end to the pixel at the extreme right end of the vertical lines (VD).

In this embodiment, in order to specify whether the vehicle existing in front of the vehicle that is traveling is a preceding vehicle, a parking vehicle or an on-coming vehicle, the pixel position of the body detected by the edge detection unit 82 is stored, and the moving direction of the body is determined based on the stored history to specify whether the body is a preceding vehicle, an on-coming vehicle or a stopping body such as a parking vehicle. For example, the vehicle traveling in the same direction as the direction in which the vehicle is now traveling, is specified to be the preceding vehicle.

The pixel position extraction unit 83 extracts the number of pixels in the vertical line (VD) direction for each horizontal line (HD) from the pixel position of the preceding vehicle extracted by the edge detection unit 82. As shown in, for example, FIG. 23, there is extracted a number of pixels (SP_{VD}) between the pixel positions at the extreme ends for each horizontal line (HD) representing the contour of the preceding vehicle (V_{R}).

The memory 84 stores the number of pixels (VP_{VD}) in the vertical line (VD) direction for each horizontal line (HD) necessary for traveling of the vehicle at the angle of field A. Referring to FIG. 6, the number of pixels is set by converting the width (VW) acquired by adding predetermined margins to the width of the vehicle into the angle of field A. Referring, for example, to FIG. 24, the number of pixels converted into the angle of field A decreases toward the upper portion of the horizontal lines (HD) in the figure when shown along the center line (LCT) of the traveling section of the road in the image.

The calculation unit 85 calculates a difference between the number of pixels (SP_{HD}) in the horizontal line (HD) direction necessary for traveling of the vehicle stored in the memory 84 and the number of pixels (VP_{HD}) in the horizontal line (HD) direction of the preceding vehicle (V_{R}) (calculates a relation of magnitude between the number of pixels (VP_{VD}) and the number of pixels (SP_{HD})) for each vertical line (VD) representing the height of the preceding vehicle (V_{R}).

The preceding vehicle passing determination unit 89 determines whether the preceding vehicle has passed through by the body such as the parking vehicle or the on-coming vehicle based on the history of pixel positions of the bodies such as the preceding vehicle, parking vehicle, on-coming vehicle, etc. detected by the edge detection unit 82. The determined result of the preceding vehicle passing determination unit 89 is sent to the vehicle passing determination unit 86.

When the preceding vehicle passing determination unit 89 determines that the preceding vehicle has passed through by the body such as the parking vehicle or the on-coming vehicle, the vehicle passing determination unit 86 determines whether the number of pixels (VP_{HD}) is smaller than the number of pixels (SP_{HD}) as a result of calculation by the calculation unit 85. The determined result is sent to the alarm generation unit 87.

When the vehicle passing determination unit 86 determines that the number of pixels (VP_{HD}) is smaller than the number of pixels (SP_{HD}), the alarm generation unit 87 generates alarm for evoking the caution of the vehicle driver. For example, an alarm is generated to notify that the vehicle cannot pass through by the body such as the parking vehicle or the on-coming car. Therefore, the driver of the vehicle learns that he cannot pass through by the body existing ahead.

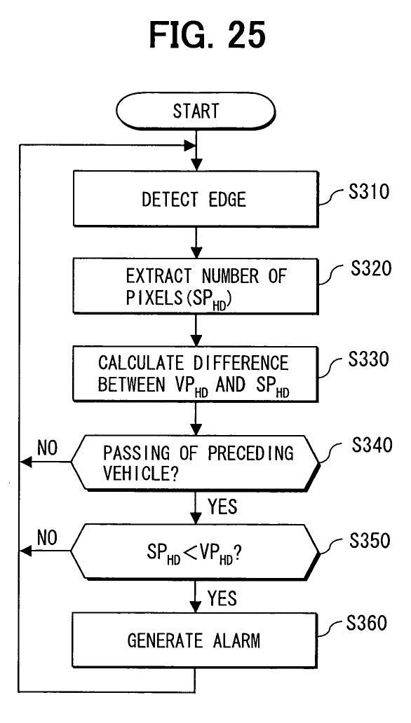

The processing for assisting the driving on a narrow road by using the vehicle driving assisting apparatus 200 will be described next with reference to a flowchart of FIG. 25. At S310, pixel positions of the travel lane on the road, preceding vehicle, parking vehicle and on-coming vehicle are extracted by the edge detection processing. At S320, the number of pixels (SP_{HD}) between the pixel positions at the extreme ends is extracted for each vertical line (VD) representing the contour of the preceding vehicle (V_{R}).

At S330, a difference between the number of pixels (VP_{HD}) in the horizontal line (HD) direction and the number of pixels (SP_{HD}) of the preceding vehicle is calculated for each horizontal line (HD) necessary for traveling of the vehicle. At S340, it is determined whether the preceding vehicle has passed through by the body such as the parking vehicle or the on-coming vehicle based on the history of pixel positions of the preceding vehicle, parking vehicle and on-coming vehicle detected at S310. When the result is affirmative, the routine proceeds to S350. When the result is negative, the routine returns to S310 to repeat the above processing.

At S350, it is determined if the number of pixels (VP_{HD}) is smaller than the number of pixels (SP_{HD}). When the result is affirmative, the routine proceeds to S360. When the result is negative, the routine proceeds to S310 to repeat the above processing. At S360, an alarm is generated to evoke the driver's caution.

As described above, the vehicle driving assisting apparatus 200 stores the number of pixels (VP_{HD}) necessary for traveling of the vehicle in the image, and calculates a difference between the number of pixels (VP_{HD}) necessary for the traveling and the number of pixels (SP_{HD}) of the preceding vehicle in the image. The apparatus 200 determines whether the preceding vehicle has passed through by the body. When it is determined that the preceding vehicle has passed through, the apparatus 200 determines whether the vehicle that is traveling can pass through by the body except the preceding vehicle based on the difference between the number of pixels (VP_{HD}) necessary for traveling of the vehicle and the number of pixels (SP_{HD}) of the preceding vehicle.

That is, even when it is determined that the preceding vehicle has passed through by the body, it often happens that the vehicle that is traveling cannot pass through by the body in case the number of pixels (VP_{HD}) necessary for traveling of the vehicle is larger than the number of pixels (SP_{HD}) corresponding to the width of the preceding vehicle (e.g., when the preceding vehicle is a compact or small-sized car and the vehicle that is traveling is a large-sized vehicle).

Therefore, when the number of pixels (VP_{HD}) necessary for traveling of the vehicle is larger than the number of pixels (SP_{HD}) corresponding to the width of the preceding vehicle, it is so determined that the vehicle that is traveling cannot pass through by the body to thereby properly determine that the vehicle that is traveling cannot pass through by the body. Unlike the prior art, therefore, there is no need of detecting the speed of the vehicle or the steering angle thereof, or of setting a line for determining the probability of contact based thereon, making it possible to quickly determine whether the vehicle can pass through while traveling on a narrow road.

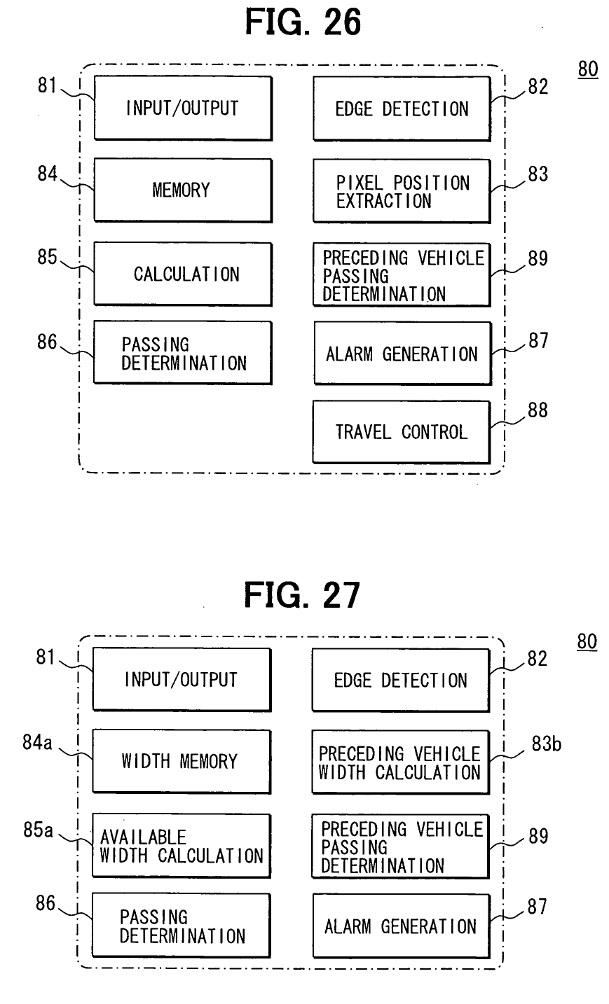

As a modification of the third embodiment, it is possible, for example, to impose limitation on the traveling of the vehicle simultaneously with the generation of alarm. As illustrated in, for example, FIG. 26, a vehicle travel control unit 88 is added as a function of the computer 80. The vehicle travel control unit 88 controls the throttle actuator 90 so that the driver's accelerator operation for vehicle acceleration is limited to limit the vehicle acceleration or to drive the brake actuator 100 to automatically apply the brake of the vehicle.

This makes it possible to prevent in advance the contact of the vehicle with the body present in the vehicle lane or to reduce the shock should the contact occurs.

### Fourth Embodiment

A fourth embodiment is shown in FIG. 27. The control processing of the computer 80 of this embodiment is divided into an input/output unit 81, an edge detection unit 82a, a vehicle width calculation unit 83a, a required traveling width memory 84a, a calculation unit 85a, a preceding vehicle passing determination unit 89a, a vehicle passing determination unit 86 and an alarm generation unit 87. The input/output unit 81 receives signals output from the sensors, and produces signals that are processed by the computer 80 and that are to be output.

The edge detection unit 82 acquires pixel values of the pixels in the angle of field in an image that has been preset out of the pixel values of the pixels of the whole image imaged by the CCD camera 60. As an angle of field for acquiring the pixel values, for example, an angle of field A is set as shown in FIG. 22 to include a vehicle lane from several meters up to several tens of meters in front of the vehicle. This is for acquiring pixel values of the pixels on the horizontal lines (HD) and on the vertical lines (VD) in the angle of field A.

Next, the edge detection unit 82 detects the edge to extract the pixel positions that indicate pixel values greater than the threshold edge value by comparing the acquired values of pixels in the angle of field with a preset threshold edge value. Thus, pixel positions of the travel lane and the vehicle on the road are extracted in the angle of field. The edge detection is repetitively effected from, for example, the uppermost portion of the vertical lines to the lowermost portion thereof in the angle of field, from the pixel at the extreme left end to the pixel at the extreme right end of the horizontal lines.

In this embodiment, in order to specify whether the vehicle existing in front of the vehicle that is traveling is a preceding vehicle, a parking vehicle or a on-coming vehicle, the pixel position of the body detected by the edge detection unit 82 is stored, and the moving direction of the body is determined based on the stored history to specify whether the body is a preceding vehicle, an on-coming vehicle or a stationary body such as a parking vehicle. For example, the vehicle traveling in the same direction as the direction in which the vehicle is now traveling, is specified to be the preceding vehicle.

The vehicle width calculation unit 83a calculates the width (SP) of the preceding vehicle from the pixel positions at the extreme right and left ends of the preceding vehicle detected by the edge detection unit 82a.

The required traveling width memory 84a stores the traveling width (VW) in the direction of vehicle width necessary for traveling of the vehicle. The calculation unit 85a calculates an available width. This available width is a difference between the required traveling width (VW) stored in the required traveling width memory 84a and the width (SP) of the preceding vehicle calculated by the vehicle width calculation unit 83a (e.g., calculates a relationship of magnitude between the required traveling width (VW) and the width (SP) of the preceding vehicle).

The preceding vehicle passing determination unit 89a determines whether the preceding vehicle has passed through by the body such as the parking vehicle or the on-coming vehicle based on the history of positions of the bodies such as the preceding vehicle, parking vehicle, on-coming vehicle, etc. detected by the edge detection unit 82. The determined result of the preceding vehicle passing determination unit 89a is sent to the vehicle passing determination unit 86.

When the preceding vehicle passing determination unit 89a determines that the preceding vehicle has passed through by the body such as the parking vehicle or the on-coming vehicle, the vehicle passing determination unit 86 determines whether the required traveling width (VW) is shorter than the width (SP) of the preceding vehicle as a result of calculation by the width calculation unit 85a. The determined result is sent to the alarm generation unit 87.

When the vehicle passing determination unit 86 determines that the required traveling width (VW) is larger than the width (SP) of the preceding vehicle, the alarm generation unit 87 generates alarm for evoking the caution of the vehicle driver.

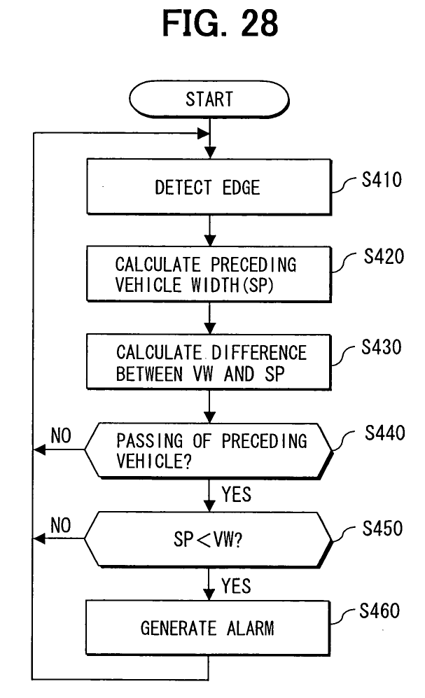

The processing for assisting the driving on a narrow road will be described next with reference to a flowchart of FIG. 28. At S410 in FIG. 28, pixel positions of the travel lane on the road, preceding vehicle, parking vehicle and on-coming vehicle are extracted by the edge detection processing. At S420, the width (SP) of the preceding vehicle is calculated. At S430, a difference between the width (VW) required for traveling of the vehicle and the width (SP) of the preceding vehicle is calculated.

At S440, it is determined whether the preceding vehicle has passed through by the body such as the parking vehicle or the on-coming vehicle based on the history of pixel positions of the preceding vehicle, parking vehicle and on-coming vehicle detected at S410. When the result is affirmative, the routine proceeds to S450. When the result is negative, the routine returns to S410 to repeat the above processing.

At S450, it is determined if the required traveling width (VW) is larger than the width (SP) of the preceding vehicle. When the result is affirmative, the routine proceeds to S460. When the result is negative, the routine proceeds to S410 to repeat the above processing. At S460, an alarm is generated to evoke the driver's caution.

As described above, the vehicle driving assisting apparatus 200 stores the width (VW) required for traveling of the vehicle, and calculates a difference between the required traveling width (VW) and the width (SP) of the preceding vehicle. When it is determined that the preceding vehicle has passed through by the body, the apparatus 200 determines whether the vehicle that is traveling can pass through by the body other than the preceding vehicle based on the result of determination of whether the required traveling width (VW) is larger than the width (SP) of the preceding vehicle. This makes it possible to properly determine that the vehicle that is traveling cannot pass through by the body.

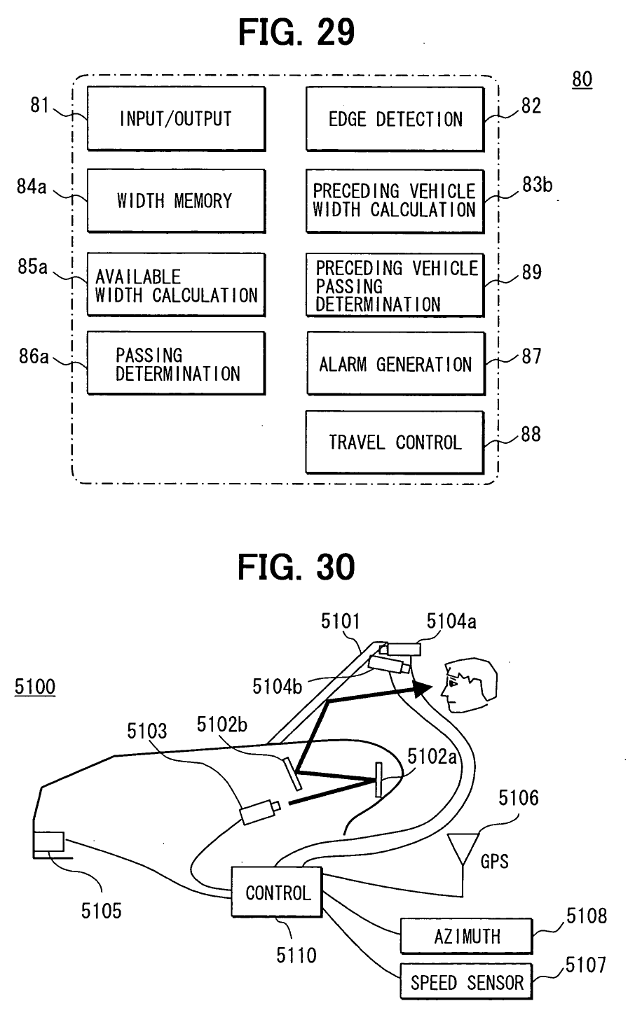

As a modification of the fourth embodiment, it is possible, for example, to impose limitation on the traveling of the vehicle simultaneously with the generation of alarm at S460. As illustrated in, for example, FIG. 29, a vehicle travel control unit 88 is added as a function of the computer 80. The vehicle travel control unit 88 controls the throttle actuator 90 so that the driver's accelerator operation for vehicle acceleration is disabled to limit the accelerator operation for the vehicle acceleration or to drive the brake actuator 100 to automatically apply the brake of the vehicle. This makes it possible to prevent in advance the contact of the vehicle with the body present in the vehicle lane or to reduce the shock should the contact occurs.

### Fifth Embodiment

Referring to FIG. 30, a display device 5100 for a vehicle is comprised of a windshield 5101 of a vehicle, mirrors 5102a, 5102b, a display unit 5103, cameras 5104a, 5104b, a laser radar 5105, a GPS antenna 5106, a vehicle speed sensor 5107, an azimuth sensor 5108 and a control unit 5110.

The windshield 5101 is a front window of the vehicle and has the surface treated so as to function as a combiner on the inside of the vehicle compartment. The region of which the surface is treated is a display region to where the display light will be projected from the display unit 5103. That is, the display region of a known head-up display is set on the windshield 5101. A user who is seated on the driver's seat in the compartment sees the image projected onto the display region by the display light output from the display unit 5103 when he sees the real scenery in front of the vehicle.

The mirrors 5102a and 5102b are reflectors for guiding the display light output from the display unit 5103 up to the windshield 5101. The mirrors 5102a and 5102b are so provided that their angles of inclination can be adjusted, and maintains the angles depending upon the instruction signals from the control unit 5110. The display unit 5103 acquires image data from the control unit 5110, and outputs the acquired image data after having converted them into display light. The display light that is output is projected onto the display region of the windshield 5101 via the mirrors 5102a and 5102b.

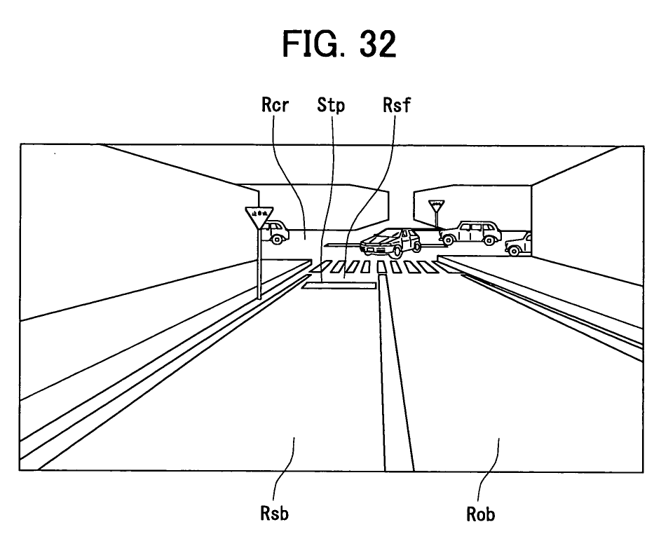

The camera 5104a is an optical camera used for imaging the image inclusive of road in front of the vehicle as shown, for example, in FIG. 32, and outputs, to the control unit 5110, the image signals comprising horizontal and vertical synchronizing signals of the image that is imaged and pixel value signals representing the degree of brightness for each pixel of the image.

The camera 5104b is comprised of, for example, a CCD camera. A view point position (eye point) of the user in the vehicle is detected based on the image that is imaged by using the camera 5104b.

The laser radar 5105 projects a laser beam onto a predetermined range in front of the vehicle to measure a distance to the body that reflects the laser beam, a speed relative to the body, and the amount of deviation in the transverse or lateral direction from the center of the vehicle in the direction of width of the vehicle. The measured results are converted into electric signals and are output to the control unit 5110.

The GPS antenna 5106 is for receiving electromagnetic waves transmitted from the known GPS (global positioning system) satellite, and sends the received signals as electric signals to the control unit 5110. The vehicle speed sensor.5107 is for detecting the speed of the vehicle that is traveling, and sends the detection signal to the control unit 5110. The azimuth sensor 5108 is comprised of a known terrestrial magnetism sensor or a gyroscope, detects an absolute azimuth in a direction in which the vehicle is traveling and the acceleration produced by the vehicle, and sends the detection signals as electric signals to the control unit 5110.

Based on the signals from the above units and sensors, the control unit 5110 forms an image to be displayed on the display region set on the windshield 5101, and outputs the image data of the formed display image to the display unit 5103.

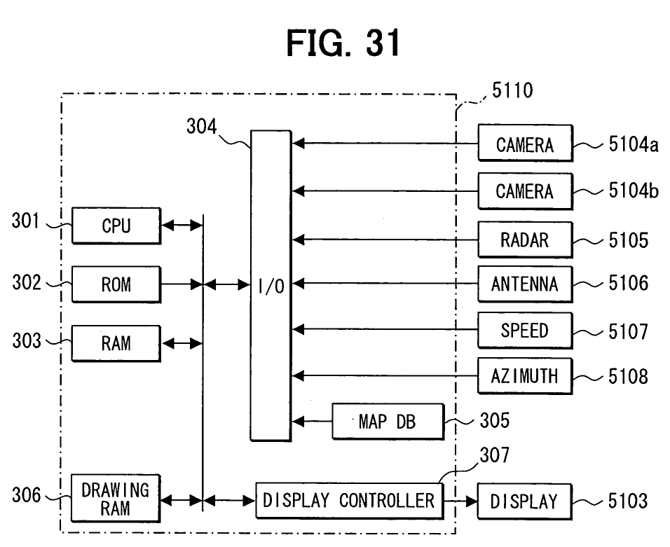

Referring to FIG. 31, the control unit 5110 includes a CPU 301, a ROM 302, a RAM 303, an input/output unit 304, a map database (map DB) 305, a drawing RAM 306 and a display controller 307.

The CPU 301, ROM 302, RAM 303 and drawing RAM 306 are comprised of known processors and memory modules. The CPU 301 uses the RAM 303 as a temporary storage region for temporarily storing the data, and executes various kinds of processing based on the programs stored in the ROM 302. The drawing RAM 306 stores the image data that are to be output to the display unit 103.

The input/output unit 304 receives signals from the cameras 5104a, 5104b, laser radar 5105, GPS antenna 5106, vehicle speed sensor 5107 and azimuth sensor 5108, as well as various data from the map DB 305, and works as an interface for sending outputs to the CPU 301, RAM 303, drawing RAM 306 and display controller 307.

The map DB 305 is a device for storing map data including data related to road signs, road indications, traffic regulations and instructions on the road such as signals and the like. From the standpoint of the amount of data, the map DB 305 uses, as a storage medium, a CD-ROM or a DVD-ROM, though there may also be used a writable storage medium such as a memory card or a hard disk. The data related to the traffic regulations and instructions of the road may include road signs, road indications, positions where the signals are installed and contents of the traffic regulations and instructions.

The display controller 307 reads the image data stored in the drawing RAM 306, calculates the display position such that the image is displayed at a suitable position on the windshield 5101, and outputs the display position to the display unit 5103.

The display device 5100 recognizes the road in front of the vehicle from the image that is imaged by the camera 5104a, extracts the pixel position of the recognized road, acquires the data related to the traffic regulations and instructions corresponding to the recognized road, and determines the degree of caution by which the user should give caution to the road in front of the vehicle based on the acquired data related to the traffic regulations and instructions.

On the other hand, from the image that is imaged by the camera 5104b, the eye point of a user who is sitting on the driver's seat in the compartment of the vehicle is detected. Based on the position of the eye point, a position is specified in the display region of the windshield 5101 corresponding to the pixel position of the road that is extracted.

The display device 5100 forms an image displaying the region of the road in a mode that differs depending upon the determined degree of caution, and displays the thus formed image at the position of the road in the display region of the windshield 5101 that is specified.

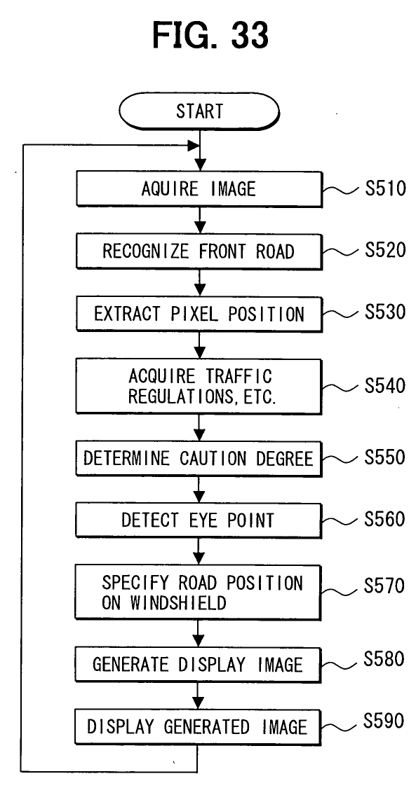

Next, the processing of the display device 5100 will be described by using a flowchart illustrated in FIG. 33. First, at step (S) 510, an image that is imaged by the camera 5104a is acquired. For example, an image is acquired including the road in front of the vehicle as shown in FIG. 32.

At S520, a front road is recognized from the acquired image. As for a method of recognizing the road from the image, the road is recognized relying upon the image analyzing method such as texture analysis. Further, when a lane line is drawn on the road in front of the vehicle to divide the travel lanes as shown in FIG. 32, the traveling lane of the road is recognized.

At S530, the pixel positions of the road recognized at S520 are extracted. When the lane line is drawn on the road in front of the vehicle as shown in FIG. 32, the pixel positions of the lane line of the road are extracted.

At S540, the data related to the traffic regulations and instructions corresponding to the road recognized at S520 are acquired from the map DB 305. In acquiring the data related to the traffic regulations and instructions from the map DB 305, the present position of the vehicle and the direction of traveling are grasped based on the signals received by the GPS antenna 5106 and on the signals from the azimuth sensor 5108, and the data related to the traffic regulations and instructions corresponding to the road existing in front of the vehicle are acquired. As for the data related to the traffic regulations and instructions by the signals, the data may be acquired in real time from outside the vehicle by using known communication means that is not shown.

At S550, the degree of caution by which the user of the vehicle should give to the road in front of the vehicle is determined based on the acquired data related to the traffic regulations and instructions. When, for example, the road in front of the vehicle intersects another road and a stop sign is installed at the intersection as shown in FIG. 32, it is so determined that the degree of caution is high for the traveling lane Rsf beyond a stop line Stp drawn on the traveling lane of the vehicle, for the opposite lane Rop neighboring the traveling lane of the vehicle and for the another road Rcr that is intersecting, and that the degree of caution is low for the traveling lane Rsb on this side of the stop line Stp.

At S560, from the image that is imaged by the camera 5104b, the eye point of the user who sits on the driver's seat in the compartment of the vehicle is detected. At S570, the position of the road in the display region on the windshield 5101 of the vehicle corresponding to the pixel position of the road extracted at S530 is specified based on the position of the user's eye point detected at S550. When the lane line is drawn on the road in front of the vehicle as shown in FIG. 32, the position of the lane line is specified in the display region corresponding to the pixel position of the lane line of the road.

At step S580, an image is formed and generated to be displayed at the position of the road specified at S570. Here, an image is formed to display the road on the display region of the windshield 5101 and to display the region of the lane of the road in a mode that differs depending upon the degree of caution determined at S550.

For example, a red display color is used for a region of the road and the traveling lane which are determined to be of a high degree of caution, and a blue (clear) display color is used for a region of the road and the traveling lane which are determined to be of a low degree of caution, to acquire a display image in a mode that meets the user's sense.

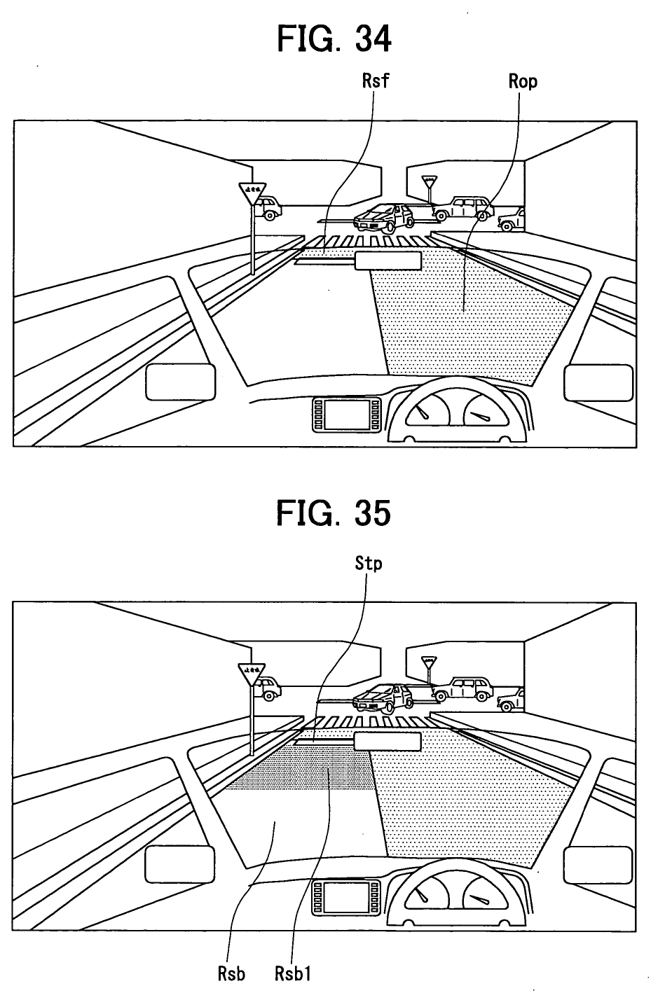

At S590, the image formed at S580 is displayed at the position of the road or the traveling lane in the display region of the windshield 5101 that is specified. As shown in FIG. 34, therefore, an image is formed displaying the traveling lane Rsf beyond the stop line positioned in the display region and the opposite lane Rop neighboring the traveling lane of the vehicle in a mode of a high degree of caution (red display color). This makes it easy to grasp the degree of caution for the road and for the traveling lane in front of the vehicle.

As described above, the display device 5100 of this embodiment acquires the data related to the traffic regulations and instructions corresponding to the road in front of the vehicle, determines the degree of caution by which the user should give caution to the road in front of the vehicle based on the acquired data related to the traffic regulations and instructions, and forms the image displaying the region of the road in a mode that differs depending upon the determined degree of caution at the position of the road in the display region on the windshield 5101.

Therefore, the user of the vehicle is allowed to grasp the degree of caution for the road in front where the traffic regulations and traffic instructions are implemented while watching forward of the vehicle and, hence, to travel the vehicle depending upon the degree of caution. As a result, a suitable display is acquired for assisting the driving.

As a first modification of this embodiment, the display device 5100 displays the image in front of the vehicle on the HUD having a display region in a portion of the windshield 5101 of the vehicle or on the display device installed near the center console to display, in an overlapped manner, the image in a mode that differs depending upon the degree of caution. This enables the user of the vehicle to grasp the degree of caution for the road in front of the vehicle.

As a second modification, the display device 5100 forms an image in a mode of display that differs depending upon the degree of caution based on a distance from the present position of the vehicle up to a point where the traffic regulations and instructions are implemented. That is, concerning the traveling lane Rsb on this side of the stop line Stp drawn on the traveling lane of the vehicle as shown in FIG. 35, it is so determined that the degree of caution is high when the distance is short up to the stop line Stp, and a region Rsb1 of the traveling lane from the stop line Stp up to a predetermined distance on this side is indicated by forming a display image of, for example, a yellow display color.

Therefore, the user of the vehicle is allowed to grasp a degree that is impending in distance (time) to arrive at a point where the traffic regulations and instructions are implemented and, hence, to quickly judge the operation which is to be conducted by the user of the vehicle. The traveling lane Rsb on this side of the stop line Stp may be displayed by forming an image in display colors that continuously vary depending upon the distance.

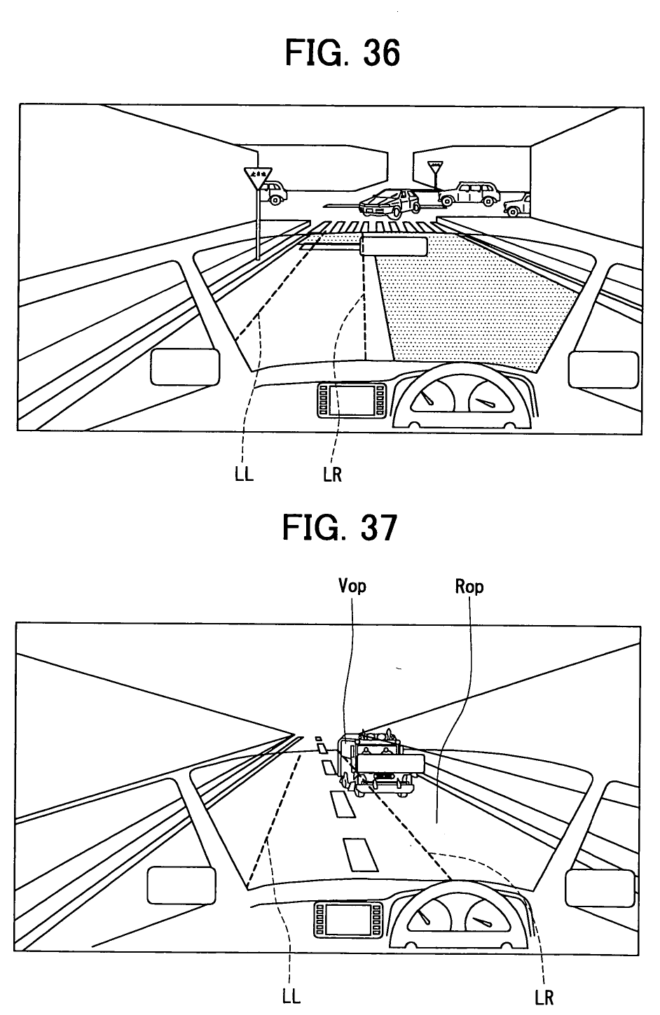

As a third modification as shown in FIG. 36, a display image is formed to indicate future traveling loci (expected travel path) LL, LR of the vehicle and is displayed on the display region of the windshield 5101. This enables the user to grasp a positional relationship between the future traveling loci of the vehicle and the display image in a display mode that differs depending upon the degree of caution. Therefore, the user of the vehicle can determine whether he is heading toward the road to which caution must be given.

Concerning the future traveling loci of the vehicle, the traveling state of the vehicle may be detected based on the signals from the vehicle speed sensor 5107 and the azimuth sensor 5108, and the future traveling loci of the vehicle may be estimated based on the traveling state that is detected.

To display the image for displaying the future traveling loci LL, LR of the vehicle, further, an image only may be displayed meeting the degree of caution for the traveling lane of the vehicle instead of displaying an image that meets the degree of caution for the other traveling lane neighboring the traveling lane of the vehicle. This makes the user feel less complicated the displayed image is.

As a fourth modification, the probability of collision with the body is determined based upon the position of the body relative to the vehicle detected by the laser radar 5105 and upon the future traveling loci of the vehicle, and an image is displayed indicating traveling loci in a mode that differs depending upon the degree of probability of collision that is determined.

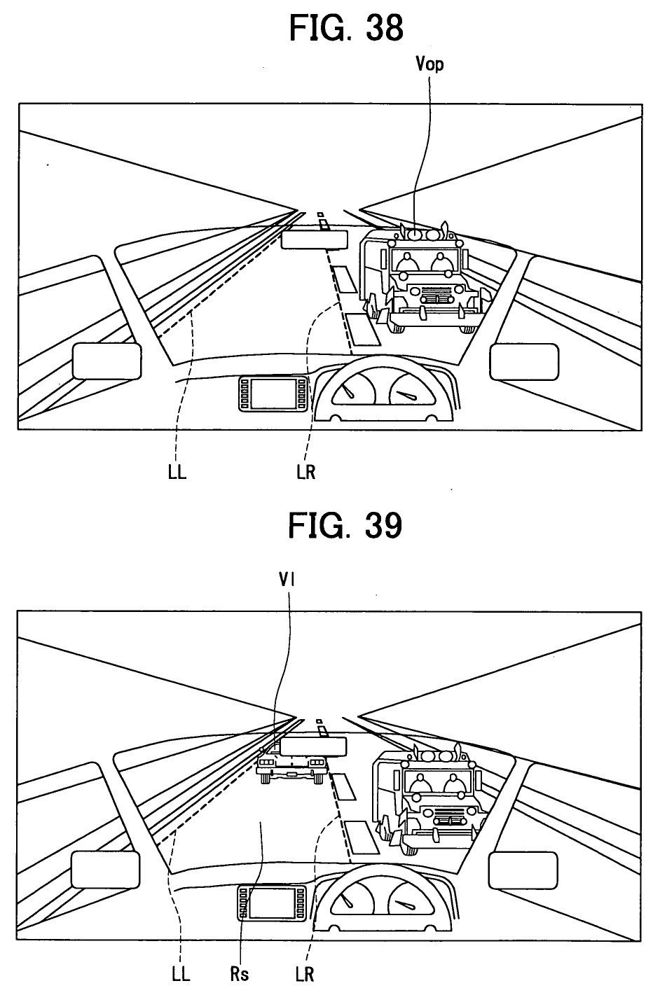

When the on-coming vehicle V_{OP} in the opposite lane Rop is overlapping the image displaying the traveling loci LL, LR as shown, for example, in FIG. 37, the image of the traveling loci LL, LR is displayed in, for example, a red display color to indicate that the probability of collision with the on-coming vehicle V_{OP} is high. Or, when the on-coming vehicle Vop does not overlap the image displaying the traveling loci LL, LR as shown in, for example, FIG. 38, the probability of collision with the on-coming vehicle V_{OP} is low, and the image displays the traveling loci (LL, LR) in, for example, a blue display color.

Therefore, even when the degree of caution is low concerning the traffic regulations and instructions in front of the vehicle, the user is allowed to grasp the probability of collision with the body in case the probability of collision with the body in front of the vehicle is high.

When the probability of collision with the body is determined to be low, the image may not display the future traveling loci of the vehicle but, instead, the image may display the future traveling loci of the vehicle only when the probability of collision is determined to be high. Therefore, the image displays the future traveling loci of the vehicle only when the probability of collision with the body is high, making it possible to effectively assist the driving.

Referring to FIG. 39, further, when the preceding vehicle V1 in the traveling lane Rs of the vehicle is located on the traveling loci LL, LR, the degree of probability of collision with the preceding vehicle may be determined depending upon the distance up to the preceding vehicle V1, and the image may display the traveling loci in a mode that differs depending upon the degree that is determined.

Further, the image may display only the future traveling loci of the vehicle without displaying the image that corresponds to the degree of caution related to the traffic regulations and instructions of the road in front of the vehicle.

The present invention should not be limited to the above embodiments and modifications, but may be modified further in many other ways.

1. A vehicle driving assisting apparatus comprising:
imaging means for imaging a front image in front of a vehicle;
determining means for determining, based on the image imaged by the imaging means, whether the vehicle can pass through when the vehicle travels by the body;
body detecting means for detecting a road in front of the vehicle from the image imaged by the imaging means and for detecting pixel positions in the image of a body existing on the road;
storage means for storing the number of pixels in a horizontal direction of the image corresponding to the pixel positions in a vertical direction of the image necessary for traveling of the vehicle in the image;
extraction means for extracting only those pixel positions of the road where the body is absent as detected by the body detecting means; and
calculation means for calculating a relation of the number of pixels in the horizontal direction extracted by the extraction means to the number of pixels in the horizontal direction stored in the storage means for each of the pixel positions in the vertical direction of the image,
wherein the determining means makes a determination based on the relation of the number of pixels calculated by the calculation means.

2. The vehicle driving assisting apparatus as in claim 1, wherein the determining means determines that the vehicle cannot pass through by the body when a ratio of the number of pixels in the horizontal direction extracted by the extraction means to the number of pixels in the horizontal direction stored in the storage means is smaller than a predetermined ratio corresponding to a width of the vehicle.

3. The vehicle driving assisting apparatus as in claim 1, wherein the calculation means calculates, as the relation of the numbers of pixels, a ratio of the number of pixels in the horizontal direction extracted by the extraction means to the number of pixels in the horizontal direction stored in the storage means in a range of pixel positions in the vertical direction of the image of the body existing on the road.

4. The vehicle driving assisting apparatus as in claim 1, wherein:
the body detecting means detects, in the image, the pixel positions of the horizontal edges of a vehicle lane indicating a traveling section of the vehicle on the road in front of the vehicle and of the body existing on the vehicle lane; and
the extraction means extracts only those pixel positions in the vehicle lane where the body is not existing as detected by the body detecting means.

5. The vehicle driving assisting apparatus as in claim 1, wherein:
the body detecting means detects, in the image, the pixel positions of horizontal edges of a vehicle lane indicating a traveling section of the vehicle on the road in front of the vehicle, of the body existing on the vehicle lane and of the body existing on a lane opposite to the vehicle lane; and
the extraction means extracts the pixel positions in the vehicle lane where the body is absent or extracts the pixel positions between a left edge of the vehicle lane and an extreme left end of the body on the opposite lane where the body is absent as detected by the body detecting means, when the pixel position at the extreme left end of the body existing on the opposite lane as detected by the body detecting means is on the left of the pixel position of the right edge of the vehicle lane in the image or when the number of pixels in the horizontal direction of the image between the pixel position at the extreme left end of the body existing on the opposite lane and the pixel position of the right edge of the vehicle lane, is smaller than a preset number of pixels corresponding to the pixel positions in the vertical direction of the image.

6. A vehicle driving assisting apparatus comprising:
imaging means for imaging a front image in a direction in which the vehicle is traveling;
body detecting means for detecting boundary positions at left and right of a road in which the vehicle is traveling and extreme left and right end positions of the body on the road from the image imaged by the imaging means;
necessary traveling width storage means for storing a traveling width necessary for the vehicle to travel; and
passing determination means for determining whether the vehicle can pass through when the vehicle travels by the body based on the boundary positions at the left and right of the road detected by the body detecting means, the extreme horizontal end positions of the body and the necessary traveling width stored in the necessary traveling width storage means.

7. The vehicle driving assisting apparatus as in claim 6, wherein:
the body detecting means includes calculation means for calculating a length of both a left-side available width representing a length of from the extreme left end position of the body to the left boundary position of the road or a right-side available width representing a length of from the extreme right end position of the body to the right boundary position of the road; and
the passing determination means determines that the vehicle cannot pass through by the side of the body when the left-side available width and the right-side available width calculated by the calculation means are both shorter than the necessary traveling width.

8. The vehicle driving assisting apparatus as in claim 6, wherein:
the body detecting means detects horizontal edge positions of the vehicle lane indicating a traveling section of the vehicle as the horizontal boundary positions of the road, and detects the horizontal extreme end positions of the body located within the horizontal edges of the vehicle lane as the horizontal extreme end positions of the body;
the body detecting means includes calculation means for calculating the length of a left-side available width representing a length of from the extreme left end position of the body to the left edge position of the vehicle lane and a right-side available width representing the length of from the extreme right end position of the body to the right edge position of the vehicle lane as detected by the body detecting means; and
the passing determination means determines that the vehicle cannot pass through by the side of the body when the left-side available width and the right-side available width calculated by the calculation means are both shorter than the necessary traveling width.

9. The vehicle driving assisting apparatus as in claim 8, wherein:
the body detecting means further detects the extreme horizontal end positions of an on-coming vehicle traveling on a lane opposite to the vehicle lane; and
the calculation means calculates a length from the extreme right end position of the body to an extreme left end position of the on-coming vehicle as the right-side available width when the extreme left end position of the on-coming vehicle detected by the body detecting means has a distance to the center of the vehicle lane shorter than that from the right edge position of the vehicle lane, or when the distance between the extreme left end position of the on-coming vehicle and the right edge position of the vehicle lane is smaller than a predetermined distance.

10. The vehicle driving assisting apparatus as in claim 6, wherein:
the body detecting means detects horizontal edge positions of the vehicle lane indicating a traveling section of the vehicle as the horizontal boundary positions of the road, and detects the horizontal extreme end positions of the body located within the horizontal edges of the vehicle lane as the horizontal extreme end positions of the body;
the body detecting means includes calculation means for calculating a between-the-body available width representing a length between the extreme ends of a plurality of bodies when the plurality of bodies are detected by the body detecting means at positions of a nearly equal distance from the vehicle in the vehicle lane; and
the passing determination means determines that the vehicle cannot pass through by the side of the body when the between-the-body available width calculated by the calculation means is shorter than the necessary traveling width.

11. The vehicle driving assisting apparatus as in claim 6, further comprising:
alarm means for alarming a driver of the vehicle when it is determined by the determining means that the vehicle cannot pass through by the body.

12. The vehicle driving assisting apparatus as in claim 6, further comprising:
travel limiting means for imposing limitation on the travelling of the vehicle when it is determined by the determining means that the vehicle cannot pass through by the body.

13. The vehicle driving assisting apparatus as in claim 12, wherein the travel limiting means limits an operation acceleration of the vehicle.

14. The vehicle driving assisting apparatus as in claim 12, wherein the travel limiting means automatically applies a brake by using automatic braking means provided in the vehicle.

15. The vehicle driving assisting apparatus as in any claim 6, wherein the body detecting means excludes preceding moving vehicles on the road in front of the vehicle that is traveling from the bodies that are to be detected.

16. A vehicle driving assisting apparatus comprising-:
imaging means for imaging an image in front of a vehicle;
subject vehicle passing determining means for determining, based on the image imaged by the imaging means, whether the vehicle can pass through when the vehicle travels by the body;
detecting means for detecting, based on the image imaged by the imaging means, pixel positions in the image of a body inclusive of a preceding vehicle present in front of the vehicle;
extraction means for extracting the number of pixels in a horizontal direction of the image of the preceding vehicle detected by the detecting means for each pixel position in a vertical direction of the image;
storage means for storing the number of pixels in the horizontal direction of the image corresponding to the pixel positions in the vertical direction of the image necessary for traveling of the vehicle in the image;
calculation means for calculating a difference between the number of pixels in the horizontal direction stored in the storage means and the number of pixels in the horizontal direction extracted by the extraction means for each pixel position in the vertical direction of the preceding vehicle in the image; and
preceding vehicle passing determining means for determining whether the preceding vehicle has passed though by the body based on the history of the pixel position of the preceding vehicle detected by the detecting means and the pixel position of the body excluding the preceding-vehicle,
wherein the subject vehicle passing determining means determines, based on the difference in the numbers of pixels calculated by the calculation means, whether the vehicle can pass through by the body excluding the preceding vehicle when it is determined by the preceding vehicle passing determining means that the preceding vehicle has passed through by the body.

17. The vehicle driving assisting apparatus as in claim 16, wherein the subject vehicle passing determining means determines that the vehicle cannot pass through by the body when the number of pixels in the horizontal direction stored in the storage means is larger than the number of pixels in the horizontal direction extracted by the extraction -means, which is a difference in the number of pixels calculated by the calculation means.

18. A vehicle driving assisting apparatus comprising:
imaging means for imaging an image in front of a vehicle;
subject vehicle passing determining means for determining, based on the image imaged by the imaging means, whether the vehicle can pass through when the vehicle travels by the body;
detecting means for detecting a position of a body inclusive of a preceding vehicle present in front of the vehicle from the image imaged by the imaging means;
vehicle width calculation means for calculating a width of the preceding vehicle from right and left extreme ends of the preceding vehicle detected by the detecting means;
storage means for storing a traveling width necessary for traveling of the vehicle;
calculation means for calculating a difference between the required traveling width stored in the storage means and the width of the preceding vehicle calculated by the vehicle width calculation means; and
preceding vehicle passing determining means for determining whether the preceding vehicle has passed though by the body based on a history of the position of the preceding vehicle detected by the detection means and the position of the body excluding the preceding vehicle,
wherein the subject vehicle passing determining means determines, based on the difference between the required traveling width calculated by the calculation means and the width of the preceding vehicle, whether the vehicle can pass through by the body excluding the preceding vehicle when it is determined by the preceding vehicle passing determining means that the preceding vehicle has passed through by the body.

19. The vehicle driving assisting apparatus as in claim 18, wherein the subject vehicle passing determining means determines that the vehicle cannot pass through by the body when the required traveling width is larger than the width of the preceding vehicle, which is a difference between the required traveling width calculated by the calculation means and the width of the preceding vehicle.

20. The vehicle driving assisting apparatus as in claim 18, further comprising:
caution evoking means for evoking caution of a vehicle driver when it is determined by the subject vehicle passing determining means that the vehicle cannot pass through by the body.

21. The vehicle driving assisting apparatus as in claim 18, further comprising:
traveling limiting means for imposing limitation on the traveling of the vehicle when it is determined by the determining means that the vehicle cannot pass through by the body.

22. The vehicle driving assisting apparatus as in claim 21, wherein the traveling limiting means limits an accelerator operation of the vehicle.

23. The vehicle driving assisting apparatus as in claim 21, wherein the vehicle is equipped with automatic braking means for automatically driving a braking device, and the traveling limiting means automatically applies the brake by the automatic braking means.

24. A vehicle driving assisting device comprising:
imaging means for imaging an image inclusive of a road in front of a vehicle;
display means having a display region on a windshield of the vehicle, and displaying an image on the display region being overlapped on the road in front of the vehicle so as to be viewed in the vehicle;
recognizing means for recognizing the road in the image imaged by the imaging means;
acquiring means for acquiring data related to traffic regulations and instructions corresponding to the road recognized by the recognizing means;
determining means for determining a degree of caution by which caution should be given to the road in front of the vehicle based on the data related to traffic regulations and instructions acquired by the acquiring means;
forming means for forming an image in a mode of display that differs depending upon the degree of caution determined by the determining means;
extracting means for extracting the position in the image of the road recognized by the recognizing means;
view point position-detecting means for detecting a view point position of a viewer in the vehicle;
specifying means for specifying a position of the road in the display region corresponding to the position of the road in the image extracted by the extracting means based upon a result detected by the view point position-detecting means; and
display control means for displaying the image formed by the forming means at the position of the road specified by the specifying means.

25. A vehicle driving assisting apparatus comprising:
imaging means for imaging an image inclusive of a road in front of a vehicle;
display means for displaying the image imaged by the imaging means, recognizing means for recognizing the road in the image imaged by the imaging means;
acquiring means for acquiring data related to traffic regulations and instructions corresponding to the road recognized by the recognizing means;
determining means for determining a degree of caution by which caution should be given to the road in front of the vehicle based on the data related to traffic regulations and instructions acquired by the acquiring means;
forming means for forming an image in a mode of display that differs depending upon the degree of caution determined by the determining means;
extracting means for extracting a position in the image of the road recognized by the recognizing means; and
display control means for displaying the image formed by the forming means overlapped on the position of the road extracted by the extraction means at the time of displaying the image on the display means.

26. The vehicle driving assisting 4 apparatus as in claim 25, wherein the forming means forms the image to display a region of the road recognized by the recognizing means.

27. The vehicle driving assisting apparatus as in claim 25, wherein:
the recognizing means recognizes a lane line that divides a traveling lane of the road in front of the vehicle;
the acquiring means acquires the data related to the traffic regulations and instructions corresponding to the traveling lane;
the determining means determines the degree of caution for the road in the traveling lane;
the forming means forms the image to display the region of the traveling lane; and
the display control means displays the image overlapped on the position of the traveling lane of the road.

28. The vehicle driving assisting apparatus as in claim 27, wherein:
the acquiring means acquires a distance from a position of the vehicle up to a point where the traffic regulations and instructions are implemented as data related to the traffic regulations and instructions;
the determining means determines that the degree of caution is high when the distance is shorter than a predetermined reference; and
the forming means forms the image in the display mode that differs depending upon the degree of caution based on the distance as the image to be displayed.

29. The vehicle driving assisting apparatus as in claim 26, further comprising:
traveling state-detecting means for detecting a traveling state of the vehicle;
traveling loci-estimating means for estimating a future traveling loci of the vehicle in the image based on the traveling state detected by the traveling state-detecting means;
the forming means further forms the image to display the traveling loci estimated by the traveling loci-estimating means; and
the display control means further displays the image to display the traveling loci.

30. The vehicle driving assisting apparatus as in claim 29, further comprising:
body detecting means for detecting a position of a body existing on the road in front of the vehicle relative to the vehicle; and
collision probability determining means for determining a probability of collision with the body based on the traveling loci estimated by the traveling loci-estimating means and on a relative position detected by the body detecting means,
wherein the forming means forms the image in the display mode that differs depending upon the degree of probability of collision with the body as image displaying the traveling loci.

31. The vehicle driving assisting apparatus as in claim 24, wherein the forming means forms the image in a display mode of which a display color differs depending upon the degree of caution.
